(19) United States
(12) Patent Application Publication
(10) Pub. No.: US 2019/0369570 A1
(43) Pub. Date: Dec. 5, 2019

(54) SYSTEM AND METHOD FOR AUTOMATICALLY DETECTING ANOMALIES IN A POWER-USAGE DATA SET

(71) Applicant: Mitsubishi Electric US, Inc., Cypress, CA (US)

(72) Inventor: Zafer SAHINOGLU, Irvine, CA (US)

(21) Appl. No.: 16/367,491

(22) Filed: Mar. 28, 2019

Related U.S. Application Data
(60) Provisional application No. 62/677,964, filed on May 30, 2018.

(51) Int. Cl. G05B 13/04; G06N 5/02; G05F 1/66

(52) U.S. Cl. CPC G05B 13/04; G06Q 50/06; G05F 1/66; G06N 5/025

(57) ABSTRACT

A method is provided of detecting anomalies in a power-usage data set, comprising: receiving historical data regarding power usage in a building over a time period; receiving metrics for a plurality of categories related to the historical data; receiving rules for the plurality of categories; building a model for each of the plurality of categories via a processor, by transforming the historical data into a user-readable format based on the metrics, the model including a plurality of histograms; receiving observation data after building the model for each of the plurality of categories, the observation data including at least one data entry relating to power usage in the building during a time interval after the time period; and detecting at least one anomaly in at least one of the plurality of categories via the processor using the plurality of histograms, the observation data, and the rules.

### CROSS-REFERENCE TO RELATED APPLICATIONS

This application claims priority from provisional application 62/677,964, filed on 30 May 2018, titled “SYSTEM AND METHOD FOR AUTOMATICALLY DETECTING ANOMALIES IN A POWER-USAGE DATA SET,” the contents of which are incorporated by reference in their entirety.

### FIELD OF THE INVENTION

The present invention relates generally to a system and method for automatically detecting anomalies in a power-usage data set. More particularly, the present invention relates to a system and method that can automatically identify when an anomaly appears in a variety of anomaly categories in a power-usage data set for a building to be powered based on a variety of anomaly metrics and anomaly rules.

### BACKGROUND OF THE INVENTION

A structure or device that consumes large amounts of power may have a system in place to monitor that power usage. This system can gather a set of power-usage data relating to the power usage of the device or structure. This power-usage data can then be used to assist in maximizing the efficiency of the power usage of the device or structure.

For example, a building can potentially use large amounts of power for such things as air conditioning, elevators, lights, and powered devices. The building may have a system in place that monitors the power usage for the building throughout the day, gathering different sets of data regarding the power usage in the building, as well as other related pieces of data, such as time, weather, temperature, building occupancy, etc.

The power-usage data gathered by the monitoring system can then be used to help maximize the efficiency of the building power consumption. Knowing when power is used and for what can allow a building power manager or power management system to know how to most efficiently provide power to the various building systems.

One kind of information that can be useful to a power manager or a power management system is the presence of anomalous data in the power-usage data set. An anomaly exists when a piece of the gathered power-usage data is sufficiently outside of an expected data range to qualify as normal or usual. The specific parameters that define a piece of data as anomalous can be defined by a set of anomaly rules set by a user or a power-control system.

Some examples of instances of anomalous data include: total power usage being outside of an expected total power usage range, peak power usage being outside of an expected peak power usage range, average power usage over a set time being outside of an expected average power usage, etc.

Identifying anomalous data can be useful to a system user or a power-control system, since it can identify instances where a power-usage parameter for the building is outside of an expected value, and provide guidance as to how the power usage for the building may be altered to avoid future inefficiencies.

A user's time is valuable, however, and it is advantageous to maximize the effectiveness of that user's time. For example, it takes time for a user to analyze the operation of a power system for a given day. It is beneficial, therefore, to direct the user to examine system operations for a day that would provide the most benefit. Such days are often those with anomalous data from the gathered information. As a result, it is considered useful to accurately identify days for which anomalous data is received.

The anomalous data can be identified by having a user look through the power-usage data to observe when the data falls out of a range of normalcy into an anomalous range. However, given the large amounts of power-usage data that are often gathered for a building power system, such a detection method can be very inefficient and slow, and can use up valuable time on the part of a human user.

Other possible ways of detecting anomalies in a power-usage data set include exemplar-based anomaly detection and self-organized maps (SOM).

Exemplar-based anomaly detection involves summarizing a training time-series with a small set of exemplars. The exemplars are feature vectors that capture both the high frequency and low frequency information in sets of similar subsequences of the time-series, such as mean, standard deviation, mean absolute difference, number of zero crossings within a time window, etc. This method doesn't consider data normalization prior to calculating exemplars. This would increase anomaly detection error. (See, e.g., Exemplar Learning for Extremely Efficient Anomaly Detection in Real-Valued Time Series, Jones et al., Mitsubishi Electric Research Laboratories, March 2016.)

Self-organized maps is an unsupervised technique that uses a neural network. It takes time-series data as an input and assigns the time-series data onto one of N user-specified categories using a Euclidian distance-based error measure. The selection of value N heavily impacts performance results. SOM is a good choice when the number of categories is truly known. However, for time-series-based unsupervised anomaly detection, N is not known in advance.

In operation, a conventional system might take as inputs raw daily time-series data (e.g., electricity usage, gas usage, etc.) and latent variables (e.g., mean, standard deviation, maximum values, etc.) and engage an anomaly detector (e.g., exemplars or self-organizing maps) to detect a binary anomaly state (i.e., to indicate the presence or absence of an anomaly). However, for the reasons given above, this might have a high anomaly detection error, and may not be appropriate for situations in which the selection of a set of N user-specified categories is not known in advance.

It would therefore be desirable to provide an efficient system and method for automatically identifying anomalous data in a set of power-usage data for an arbitrary value of N. It would also be desirable to provide a mechanism for displaying this anomaly information in a manner that would be adapted to assist a user or a power-control system to optimize the monitored power usage in the future.

### SUMMARY OF THE INVENTION

A method is provided for detecting anomalies in a power-usage data set, comprising: receiving historical utility data regarding power usage in a building over a period of time, and storing the historical usage data in a computer memory; receiving anomaly metrics for a plurality of anomaly categories related to the historical utility data and storing the anomaly metrics in the computer memory; receiving anomaly rules for the plurality of anomaly categories and storing the anomaly rules in the computer memory; building an anomaly model for each of the plurality of anomaly categories via a data processor, by transforming the historical utility data into a user-readable format based on the anomaly metrics, the anomaly model including a plurality of corresponding histograms; receiving interval observation data after building the anomaly model for each of the plurality of anomaly categories, the interval observation data including at least one data entry relating to power usage in the building during a time interval after the period of time, and storing the interval observation data in the computer memory; and detecting at least one anomaly in at least one of the plurality of anomaly categories via the data processor using the plurality of corresponding histograms, the interval observation data, and the anomaly rules.

The method may further comprise: updating the anomaly model for each of the plurality of anomaly categories using the interval observation data.

The method may further comprise: displaying one of the plurality of corresponding histograms for one of the plurality of anomaly categories on a display device; and displaying the at least one anomaly overlaid on the one of the plurality of corresponding histograms on the display device.

The method may further comprise: normalizing the historical utility data prior to building the anomaly model for each of the plurality of anomaly categories.

The normalizing of the historical utility data may include at least one of weather normalization and occupancy normalization.

The plurality of anomaly categories may include at least one of: an average energy usage for the building above a mean energy usage within a specified operating time on a subject day, an operational average hourly energy usage for the building during the specified operating time, a non-operational average hourly energy usage for the building during a time other than the specified operating time on the subject day, a time interval between a beginning of the specified operating time and a time when an actual energy usage for the building reaches the mean energy usage, a ratio of total daily energy usage in the building to twenty-four times a daily peak value for energy usage, a highest daily power load within a set time window during the specified operating time, a total energy usage in the building for the subject day, a total energy usage in the building above the mean energy usage for the subject day, a median daily energy usage in the building on the subject day, an operating usage variability within the specified operating time, a non-operating usage variability within the time other than the specified operating time on the subject day, peak operating load timestamp and a peak operating load during the subject day.

The anomaly rules may include at least an anomaly level threshold.

The period of time for anomaly model training and generation may be as low as 90 days (3 months).

The time interval for a test data may be twenty-four hours at 15-min time intervals

The historical utility data may include a plurality of data entries, each corresponding to a different time interval in the period of time, and each of the plurality of data entries may include one or more pieces of power usage data related to a corresponding different time interval.

The operation of building the anomaly model may include: identifying a plurality of data bins, each data bin identifying an equal range of power usage from a minimum power usage among the historical utility data to a maximum power usage among the historical utility data; sorting each of the plurality of data entries into one of the plurality of data bins corresponding to a power usage associated with the corresponding one of the plurality of data entries; creating a histogram populated by data in each of the plurality of data bins.

The operation of detecting at least one anomaly may include: identifying a number of bins from the plurality of bins as being in an anomaly region based on the anomaly rules; selecting one of the plurality of bins as corresponding to the power usage in the building during the time interval from the interval observation data; determining whether the selected one of the plurality of bins is in the anomaly region; and determining that an anomaly exists for the power usage in the building during the time interval if the selected one of the plurality of bins is in the anomaly region.

The method may further comprise determining whether the interval observation data is anomalous based on the at least one anomaly in at least one of the plurality of anomaly categories.

The operation of determining whether the interval observation data is anomalous may further comprise: assigning a plurality of corresponding anomaly values to each of the plurality of anomaly categories based on whether an anomaly has been identified in a corresponding one of the plurality of anomaly category; adding together the plurality of corresponding anomaly values to create an anomaly sum for the interval observation data; comparing the anomaly sum with an anomaly threshold; and determining that the interval observation data is anomalous if the anomaly sum is greater than or equal to the anomaly threshold.

The operation of determining whether the interval observation data is anomalous may further comprise: assigning a plurality of corresponding anomaly weights to each of the plurality of anomaly categories; multiplying each of the anomaly weights by a corresponding multiplication factor based on whether an anomaly has been identified in a corresponding one of the plurality of anomaly categories to generate a plurality of corresponding anomaly values; adding together the plurality of corresponding anomaly values to create an anomaly sum for the interval observation data; comparing the anomaly sum with an anomaly threshold; and determining that the interval observation data is anomalous if the anomaly sum is greater than or equal to the anomaly threshold, wherein the corresponding multiplication factor is a set negative number if no anomaly has been identified in the corresponding one of the plurality of anomaly categories, and the corresponding multiplication factor is a set positive number if an anomaly has been identified in the corresponding one of the plurality of anomaly categories.

The method of detecting anomalies in a data set of claim 1, further comprising determining a plurality of anomaly metric values for each of a plurality of anomaly metrics; determining a plurality of corresponding correlation values between each separate pair of the plurality of anomaly metric values; determining that one of the plurality of corresponding correlation values between a first anomaly metric value of the plurality of anomaly metric values and a second anomaly metric value of the plurality of anomaly metric values is above a set correlation threshold; selecting the first anomaly metric value as a principal anomaly metric value; and discarding the second anomaly metric value.

A system is provided for detecting anomalies in a data set, comprising: a memory; and a processor cooperatively operable with the memory, and configured to, based on instructions stored in the memory, receive historical utility data regarding power usage in a building over a period of time, and storing the historical usage data in a computer memory; receive anomaly metrics for a plurality of anomaly categories related to the historical utility data and storing the anomaly metrics in the computer memory; receive anomaly rules for the plurality of anomaly categories and storing the anomaly rules in the computer memory; build an anomaly model for each of the plurality of anomaly categories via a data processor, by transforming the historical utility data into a user-readable format based on the anomaly metrics, the anomaly model including a plurality of corresponding histograms; receive interval observation data after building the anomaly model for each of the plurality of anomaly categories, the interval observation data relating to power usage in the building during a time interval after the period of time, and storing the interval observation data in the computer memory; and detect at least one anomaly in at least one of the plurality of anomaly categories via the data processor using the plurality of corresponding histograms, the interval observation data, and the anomaly rules.

The processor may be further configured to: update the anomaly model for each of the plurality of anomaly categories using the interval observation data.

The processor may be further configured to: display one of the plurality of corresponding histograms for one of the plurality of anomaly categories on a display device; and display the at least one anomaly overlaid on the one of the plurality of corresponding histograms on the display device.

The processor may be further configured to: normalize the historical utility data prior to building the anomaly model for each of the plurality of anomaly categories.

The normalizing of the historical utility data may include at least one of weather normalization and occupancy normalization.

The plurality of anomaly categories may include at least one of: an average energy usage for the building above a mean energy usage within a specified operating time on a subject day, an operational average hourly energy usage for the building during the specified operating time, a non-operational average hourly energy usage for the building during a time other than the specified operating time on the subject day, a time interval between a beginning of the specified operating time and a time when an actual energy usage for the building reaches the mean energy usage, a ratio of total daily energy usage in the building to twenty-four times a daily peak value for energy usage, a highest daily power load within a set time window during the specified operating time, a total energy usage in the building for the subject day, a total energy usage in the building above the mean energy usage for the subject day, a median daily energy usage in the building on the subject day, an operating usage variability within the specified operating time, a non-operating usage variability within the time other than the specified operating time on the subject day, and a peak operating load during the subject day.

The anomaly rules may include at least an anomaly level threshold.

The period of time may be at least 90 days.

The time interval may be twenty-four hours at 15-min time resolution.

The historical utility data may include a plurality of data entries, each corresponding to a different time interval in the period of time, and each of the plurality of data entries may include one or more pieces of power usage data related to a corresponding different time interval.

The function of building the anomaly model may include: identifying a plurality of data bins, each data bin identifying an equal range of power usage from a minimum power usage among the historical utility data to a maximum power usage among the historical utility data; sorting each of the plurality of data entries into one of the plurality of data bins corresponding to a power usage associated with the corresponding one of the plurality of data entries; creating a histogram populated by data in each of the plurality of data bins.

The function of detecting at least one anomaly may include: identifying a number of bins from the plurality of bins as being in an anomaly region based on the anomaly rules; selecting one of the plurality of bins as corresponding to the power usage in the building during the time interval from the interval observation data; determining whether the selected one of the plurality of bins is in the anomaly region; and determining that an anomaly exists for the power usage in the building during the time interval if the selected one of the plurality of bins is in the anomaly region.

The processor may be further configured to determine whether the interval observation data is anomalous based on the at least one anomaly in at least one of the plurality of anomaly categories.

During the operation of determining whether the interval observation data is anomalous, the processor may be further configured to: assign a plurality of corresponding anomaly values to each of the plurality of anomaly categories based on whether an anomaly has been identified in a corresponding one of the plurality of anomaly category; add together the plurality of corresponding anomaly values to create an anomaly sum for the interval observation data; compare the anomaly sum with an anomaly threshold; and determine that the interval observation data is anomalous if the anomaly sum is greater than or equal to the anomaly threshold.

During the operation of determining whether the interval observation data is anomalous the processor may be further configured to: assign a plurality of corresponding anomaly weights to each of the plurality of anomaly categories multiply each of the anomaly weights by a corresponding multiplication factor based on whether an anomaly has been identified in a corresponding one of the plurality of anomaly categories to generate a plurality of corresponding anomaly values; add together the plurality of corresponding anomaly values to create an anomaly sum for the interval observation data; compare the anomaly sum with an anomaly threshold; and determine that the interval observation data is anomalous if the anomaly sum is greater than or equal to the anomaly threshold, wherein the corresponding multiplication factor is a set negative number if no anomaly has been identified in the corresponding one of the plurality of anomaly categories, and the corresponding multiplication factor is a set positive number if an anomaly has been identified in the corresponding one of the plurality of anomaly categories.

The processor may be further configured to determine a plurality of anomaly metric values for each of a plurality of anomaly metrics; determine a plurality of corresponding correlation values between each separate pair of the plurality of anomaly metric values; determine that one of the plurality of corresponding correlation values between a first anomaly metric value of the plurality of anomaly metric values and a second anomaly metric value of the plurality of anomaly metric values is above a set correlation threshold; select the first anomaly metric value as a principal anomaly metric value; and discard the second anomaly metric value.

A non-transitory computer-readable medium is provided, comprising executable instructions for a method for process reconstruction, the instructions being executed to perform: receiving historical utility data regarding power usage in a building over a period of time, and storing the historical usage data in a computer memory; receiving anomaly metrics for a plurality of anomaly categories related to the historical utility data and storing the anomaly metrics in the computer memory; receiving anomaly rules for the plurality of anomaly categories and storing the anomaly rules in the computer memory; building an anomaly model for each of the plurality of anomaly categories via a data processor, by transforming the historical utility data into a user-readable format based on the anomaly metrics, the anomaly model including a plurality of corresponding histograms; receiving interval observation data after building the anomaly model for each of the plurality of anomaly categories, the interval observation data relating to power usage in the building during a time interval after the period of time, and storing the interval observation data in the computer memory; and detecting at least one anomaly in at least one of the plurality of anomaly categories via the data processor using the plurality of corresponding histograms, interval observation data, and the anomaly rules.

The instructions may be further executed to perform: updating the anomaly model for each of the plurality of anomaly categories using the interval observation data.

The instructions may be further executed to perform: displaying one of the plurality of corresponding histograms for one of the plurality of anomaly categories on a display device; and displaying the at least one anomaly overlaid on the one of the plurality of corresponding histograms on the display device.

The instructions may be further executed to perform: normalizing the historical utility data prior to building the anomaly model for each of the plurality of anomaly categories.

The normalizing of the historical utility data may include at least one of weather normalization and occupancy normalization.

The plurality of anomaly categories may include at least one of: an average energy usage for the building above a mean energy usage within a specified operating time on a subject day, an operational average hourly energy usage for the building during the specified operating time, a non-operational average hourly energy usage for the building during a time other than the specified operating time on the subject day, a time interval between a beginning of the specified operating time and a time when an actual energy usage for the building reaches the mean energy usage, a ratio of total daily energy usage in the building to twenty-four times a daily peak value for energy usage, a highest daily power load within a set time window during the specified operating time, a total energy usage in the building for the subject day, a total energy usage in the building above the mean energy usage for the subject day, a median daily energy usage in the building on the subject day, an operating usage variability within the specified operating time, a non-operating usage variability within the time other than the specified operating time on the subject day, and a peak operating load during the subject day.

The anomaly rules may include at least an anomaly level threshold.

The period of time may be at least 90 days.

The time interval may be twenty-four hours at 15-minute resolution.

The historical utility data may include a plurality of data entries, each corresponding to a different time interval in the period of time, and each of the plurality of data entries may include one or more pieces of power usage data related to a corresponding different time interval.

The operation of building the anomaly model may include: identifying a plurality of data bins, each data bin identifying an equal range of power usage from a minimum power usage among the historical utility data to a maximum power usage among the historical utility data; sorting each of the plurality of data entries into one of the plurality of data bins corresponding to a power usage associated with the corresponding one of the plurality of data entries; creating a histogram populated by data in each of the plurality of data bins.

The operation of detecting at least one anomaly may include: identifying a number of bins from the plurality of bins as being in an anomaly region based on the anomaly rules; selecting one of the plurality of bins as corresponding to the power usage in the building during the time interval from the interval observation data; determining whether the selected one of the plurality of bins is in the anomaly region; and determining that an anomaly exists for the power usage in the building during the time interval if the selected one of the plurality of bins is in the anomaly region.

The instructions may be further executed to perform: determining whether the interval observation data is anomalous based on the at least one anomaly in at least one of the plurality of anomaly categories.

In the non-transitory computer-readable medium, the operation of determining whether the interval observation data is anomalous may further comprise: assigning a plurality of corresponding anomaly values to each of the plurality of anomaly categories based on whether an anomaly has been identified in a corresponding one of the plurality of anomaly category; adding together the plurality of corresponding anomaly values to create an anomaly sum for the interval observation data; comparing the anomaly sum with an anomaly threshold; and determining that the interval observation data is anomalous if the anomaly sum is greater than or equal to the anomaly threshold.

The operation of determining whether the interval observation data is anomalous may further comprise: assigning a plurality of corresponding anomaly weights to each of the plurality of anomaly categories; multiplying each of the anomaly weights by a corresponding multiplication factor based on whether an anomaly has been identified in a corresponding one of the plurality of anomaly categories to generate a plurality of corresponding anomaly values; adding together the plurality of corresponding anomaly values to create an anomaly sum for the interval observation data; comparing the anomaly sum with an anomaly threshold; and determining that the interval observation data is anomalous if the anomaly sum is greater than or equal to the anomaly threshold, wherein the corresponding multiplication factor is a set negative number if no anomaly has been identified in the corresponding one of the plurality of anomaly categories, and the corresponding multiplication factor is a set positive number if an anomaly has been identified in the corresponding one of the plurality of anomaly categories.

The instructions may be further executed to perform: determining a plurality of anomaly metric values for each of a plurality of anomaly metrics; determining a plurality of corresponding correlation values between each separate pair of the plurality of anomaly metric values; determining that one of the plurality of corresponding correlation values between a first anomaly metric value of the plurality of anomaly metric values and a second anomaly metric value of the plurality of anomaly metric values is above a set correlation threshold; selecting the first anomaly metric value as a principal anomaly metric value; and discarding the second anomaly metric value.

A method of detecting anomalies in a power-usage data set is provided, comprising: receiving historical utility data regarding power usage in a building over a period of time, and storing the historical usage data in a computer memory; receiving a plurality of base anomaly metrics for a corresponding plurality of anomaly categories related to the historical utility data and storing the plurality of base anomaly metrics in the computer memory; receiving anomaly rules for the plurality of anomaly categories and storing the anomaly rules in the computer memory; calculating a plurality of sets of base anomaly metric values based on the historical utility data and the plurality of base anomaly metrics; filtering the plurality of sets of base anomaly metric values into a smaller plurality of sets of principal metric values, no two of the sets of principal metric values having a correlation with another one of the sets of principal metric values greater than a correlation threshold; building an anomaly model for a subset of the plurality of anomaly categories via a data processor based on the smaller plurality of sets of principal metric values, the anomaly model including a plurality of corresponding histograms; receiving interval observation data after building the anomaly model for each of the plurality of anomaly categories, the interval observation data including at least one data entry relating to power usage in the building during a time interval after the period of time, and storing the interval observation data in the computer memory; and detecting at least one anomaly in at least one of the plurality of anomaly categories via the data processor using the plurality of corresponding histograms, the interval observation data, and the anomaly rules.

### BRIEF DESCRIPTION OF THE DRAWINGS

The accompanying figures where like reference numerals refer to identical or functionally similar elements and which together with the detailed description below are incorporated in and form part of the specification, serve to further illustrate an exemplary embodiment and to explain various principles and advantages in accordance with the present disclosure.

FIG. 1 is a block diagram of a power-usage related anomaly detection system according to a disclosed embodiment;

FIG. 2 is a block diagram of a process for automatically detecting anomalies in a power-usage data set according to a disclosed embodiment;

FIG. 3 is a block diagram of a system for actuating the process of FIG. 2 for automatically detecting anomalies in a power-usage data set according to a disclosed embodiment;

FIG. 4 is a graph of power usage over time for a building according to a disclosed embodiment;

FIG. 5 is a histogram of daily peak power demand for a building over a set period of time according to a disclosed embodiment;

FIG. 6 is the histogram of FIG. 4, sorted from greatest demand to least demand according to a disclosed embodiment;

FIG. 7 is an example of a first portion of a user interface identifying anomalies in a power-usage data set by day over a period of days according to a disclosed embodiment;

FIG. 8 is an example of a second portion of a user interface identifying anomalies in a power-usage data set by day over a period of days according to a disclosed embodiment;

FIG. 9 is a flow chart of a process for automatically detecting anomalies in a power-usage data set according to a disclosed embodiment;

FIG. 10 is a flow chart of an operation of building an anomaly model from FIG. 8 according to a disclosed embodiment; and

FIG. 11 is a flow chart of an operation of generating a histogram from FIG. 9 according to a disclosed embodiment.

### DETAILED DESCRIPTION

The instant disclosure is provided to further explain in an enabling fashion the best modes of performing one or more embodiments of the present invention. The disclosure is further offered to enhance an understanding and appreciation for the inventive principles and advantages thereof, rather than to limit in any manner the invention. The invention is defined solely by the appended claims including any amendments made during the pendency of this application and all equivalents of those claims as issued.

It is further understood that the use of relational terms such as first and second, and the like, if any, are used solely to distinguish one from another entity, item, or action without necessarily requiring or implying any actual such relationship or order between such entities, items or actions. It is noted that some embodiments may include a plurality of processes or steps, which can be performed in any order, unless expressly and necessarily limited to a particular order; i.e., processes or steps that are not so limited may be performed in any order.

Much of the inventive functionality and many of the inventive principles when implemented, may be supported with or in integrated circuits (ICs), such as dynamic random access memory (DRAM) devices, static random access memory (SRAM) devices, or the like. In particular, they may be implemented using CMOS transistors. It is expected that one of ordinary skill, notwithstanding possibly significant effort and many design choices motivated by, for example, available time, current technology, and economic considerations, when guided by the concepts and principles disclosed herein will be readily capable of generating such ICs with minimal experimentation. Therefore, in the interest of brevity and minimization of any risk of obscuring the principles and concepts according to the present invention, further discussion of such ICs will be limited to the essentials with respect to the principles and concepts used by the exemplary embodiments.

The following embodiments relate to systems and methods for analyzing power-usage data and determining whether that data is anomalous for any given time period. The exemplary embodiments disclosed involve power-usage data for a building. However, this is by way of example only. The systems and methods disclosed below can be used for any situation in which it is desirable to monitor power-usage for a system that consumes power.

Anomaly Detection System

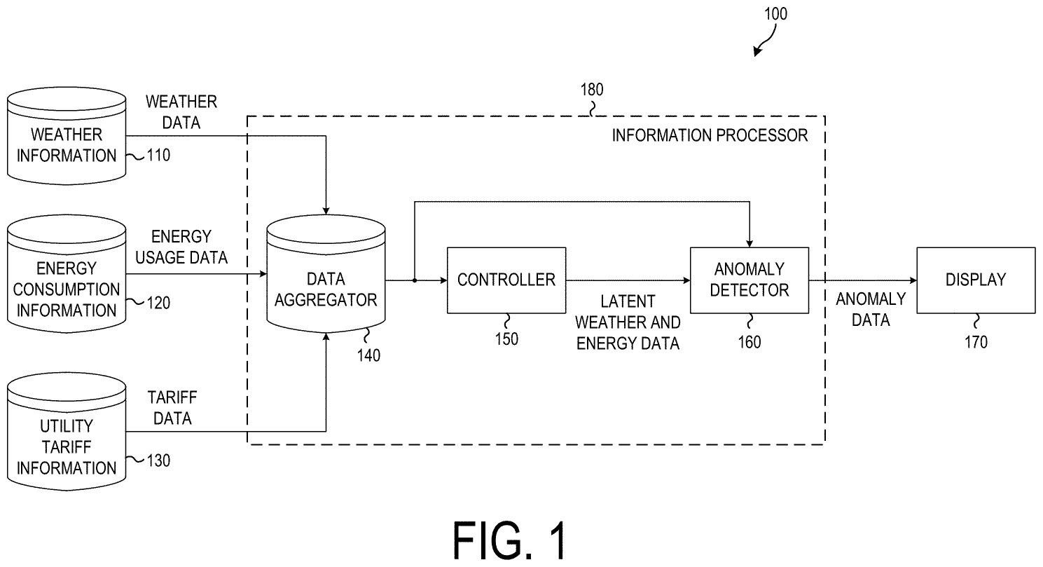

FIG. 1 is a block diagram of a power-usage related anomaly detection system 100 according to a disclosed embodiment. This power-usage based anomaly detection system 100 can calculate metric values for a power-usage data set based on a set of anomaly metrics and metric rules, and can estimate whether or not newly calculated metric values are anomalous values.

The power-usage related anomaly detection system 100 may be implemented as a building energy and automation management system used to monitor and report on energy usage in one or more buildings in order to assist the user in reducing power usage in those buildings. In one embodiment, the building energy and automation system is cloud-based. The building energy and automation management system gathers power usage data from the building and other data that are used to operate the power-usage anomaly detection system 100. The building energy and automation management system incorporates sensors, meters, and controllers installed in the building to gather the power usage data, and may transmit that data to a remote, cloud-based server for analysis by the power-usage anomaly detection system 100. The building energy and automation management system additionally gathers power usage data from utility company accounts associated with the building, and also integrates with a weather data service in order to obtain historical, current, or forecast weather data relevant to the building. Optionally, the data gathered by the building energy and automation management system are stored in a local data storage device prior to transmission to the server. Equipment in the building that may be monitored for power usage include, for example, elevators, lighting, heating and air conditioning systems, and photovoltaic systems.

As shown in FIG. 1, the power-usage forecasting system 100 includes a weather information database 110, an energy consumption information database 120, a utility tariff information database 130, a data aggregator 140, a controller 150, an anomaly detector 160, and a display 170. The data aggregator 140, the controller 150, and the forecaster 160 can be collectively considered to be an information processor 180.

The weather information database 110 gathers and stores weather information regarding the weather surrounding the target building. It can include data related to temperature, precipitation, etc., and can be identified hourly, daily, or by any other desirable interval.

The energy consumption information database 120 gathers and stores energy consumption information regarding the energy consumption of the target building. It can include information regarding the total energy used by the building, energy use over time, peak energy usage, etc., and can be identified hourly, daily, or by any other desirable interval.

The utility tariff information database 130 gathers and stores utility tariff information regarding the utility tariffs charged for the energy used by the building. This data can be identified hourly, daily, or by any other desirable interval.

The data aggregator 140 receives the weather information from the weather information database 110, the energy consumption information from the energy information database 120, and the utility tariff information from the utility tariff information database 130 and aggregates this data into a single set of data. This single set of data can be provided to the controller 150 and the anomaly detector 160.

The controller 150 is configured to process the aggregated data as necessary, and can, for example, operate to normalize the energy consumption data. It operates to generate latent weather and energy data related anomaly metrics, which it provides to the anomaly detector 160. The latent weather and energy data related anomaly metrics involve variables derived from the aggregated data. In one embodiment, the latent energy data will include a plurality of histograms representing a plurality of data metrics related to energy usage for the building.

The anomaly detector 160 receives the latent weather and energy data related anomaly metrics from the controller 150 and the aggregated data from the data aggregator 140 and uses this information to generate anomaly data indicating the presence or absence of anomaly data within the aggregated data. This anomaly data can include whether or not an anomaly has occurred for a given power-usage metric during a measured time period based on a set of historical utility data and new internal observation data, or whether or not the power consumption in the system was anomalous for a given time period based on the presence or absence of anomalies in the various power-usage metrics for that time period.

The display 170 is configured to display the aggregated data, the latent data, and the anomaly data in a way that highlights the anomaly data so that the anomalies can be more easily identified by a user. For example, the latent data can be displayed in histogram format with the anomaly data specifically called out in the display 170.

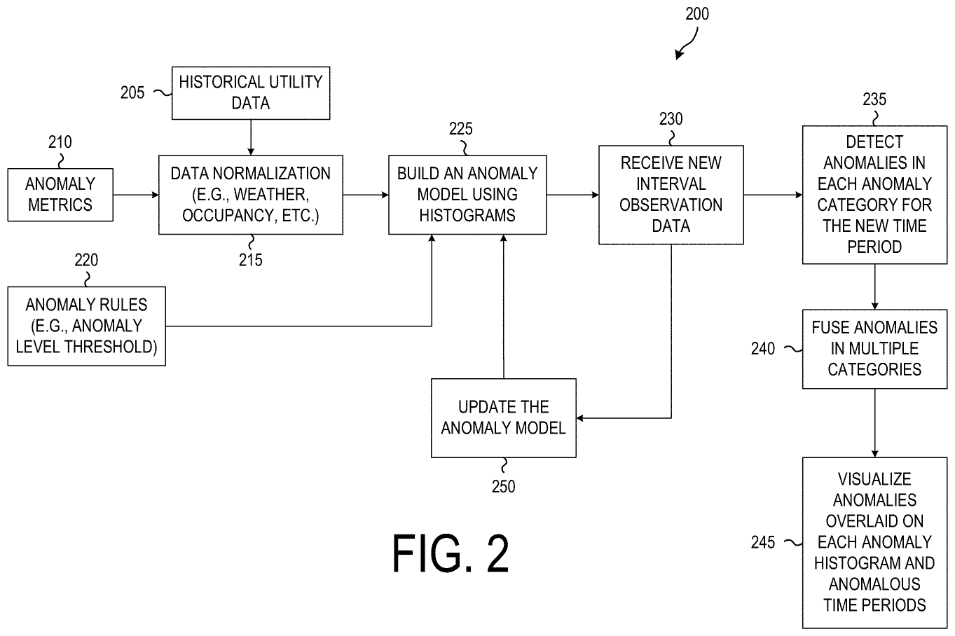

FIG. 2 is a block diagram of a process 200 for automatically detecting anomalies in a power-usage data set according to a disclosed embodiment.

As shown in FIG. 2, the process 200 includes historical utility data 205, anomaly metrics 210, data normalization 215, anomaly rules 220, building an anomaly model using histograms 225, receiving a new internal observation data 230, detecting anomalies in each anomaly category for a new time period 235, fusing anomalies in multiple categories 240, visualizing anomalies overlaid in anomaly histograms and anomalous time periods 245, and updating the anomaly model 250.

The historical utility data 205 is a group of raw data that has been previously gathered relating to the weather surrounding a building, the energy consumption of the building, and the utility tariffs imposed upon the building over a certain time duration. In this way, the historical utility data represents the aggregate data from FIG. 1. The historical utility data 205 is gathered for a number of equal time periods within the time duration.

In one embodiment, the historical utility data 205 includes measured information regarding the weather, energy consumption, building occupancy level, and utility tariff information for a set number of immediately consecutive days (e.g., 1096 days) prior to the present day. This can include temperature data, precipitation data, total energy consumed for a day, energy cost per kilowatt-hour, etc. The same information is gathered for each prior day, providing a database of 1096 different values for each data category.

The anomaly metrics 210 define a number of variables that can be derived from the historical utility data 205. This can include such information as the average (mean) energy usage over a day, the standard deviation of energy usage over a day, the maximum energy consumed over a day, etc. The anomaly metrics are the formulas that are used to calculate the latent power-usage variables.

The data normalization 215 involves normalizing the historical utility data 205 based on certain factors. The data normalization can be made based on weather data such as heating or cooling degree days or heating or cooling degree hours, occupancy data, or any other set of data that might cause a variation in the data. For example, if weather normalization is used, the historical data 205 could be normalized based on what the temperature and precipitation were over a given time period. It might be expected that the power usage would be greater when the temperature was relatively high or relatively low, or when it was raining or snowing. Data normalization for the weather can even all of this out, providing data for which the variance due to the weather is controlled.

This can help better identify anomalous power-usage days. One reason for this is that certain temperature ranges or precipitation categories might provoke more anomalous results. However, these anomalous results could be based entirely on the weather and not on another cause that might warrant closer investigation (e.g., equipment malfunction, poor equipment settings, etc.). By normalizing for the weather, the system 100, 200 can focus on the anomalies that are caused by factors other than the weather. The same is true for normalizing for occupancy. In this way, the system 100, 200 can focus on the anomalies that are caused by factors other than occupancy issues.

Although FIG. 2 discloses the use of a data normalization operation 215, this is not required in every embodiment. Alternate embodiments could omit the data normalization operation 215.

The anomaly rules 220 provide information that allows the system 100, 200 to determine whether or not observed data is anomalous. For example, the anomaly rules 220 could include an anomaly level threshold that indicates a percentage value. Observed values that fall within this percentage value in an anomaly metric (high, low, or away from a central value, as desired) can be considered anomalous. A different anomaly rule could be provided for each anomaly metric.

For example, an anomaly rule for total power usage over a given time period might be a percentage value (e.g., 1%, 5%, etc.) as an anomaly level threshold. Any measured value for total power usage that fell within the lowest percentage value of previous values totaling the anomaly level threshold might be considered anomalous, while any measured value for total power usage that fell above the lowest percentage value of previous values totaling the anomaly level threshold might be considered normal (i.e., not anomalous).

The building of an anomaly model using histograms 225 involves building a plurality of histograms, one for each of the plurality of anomaly metrics using the historical utility data 205 and the anomaly metrics 210 (as normalized during the data normalization operation 315). Each histogram divides a set of anomaly metric data into a plurality of even-sized bins defined by the possible values that the anomaly metric could have, and populates the bins based on how many of the anomaly metric values fall into each respective bin range. In this way a histogram is generated for each of the calculated anomaly metrics.

The receiving of a new internal observation data 230 involves receiving new data for calculating new anomaly metrics for a new time period. For example, in the disclosed embodiment the historical utility data initially includes 1096 sets of data corresponding to 1096 immediately previous days. The new internal observational data 230 thus initially involves receiving new data to calculate anomaly metric data for a 1097^{th} day. As time progresses, the new internal observation data 230 will move to the next time period and so forth (e.g., to a 1098^{th} day, a 1099^{th} day, etc.).

In each case, the new internal observation data 230 will represent the data collected and the anomaly metric values calculated for the immediately previous time period (e.g., the immediately previous day).

The detecting of anomalies in each anomaly category for a new time period 235 involves taking the calculated anomaly metric values for the immediately previous time period and determining whether or not those values were anomalous for each separate anomaly metric based, at least in part, on the anomaly model and the anomaly rules 220.

The anomaly rules 220 are used to define what portions of a corresponding histogram are considered anomalous and what portions of a corresponding histogram are normal (i.e., not anomalous). These anomaly rules 220 can define certain bins in each histogram as being normal bins and certain bins in each histogram as being anomalous. The system 100, 200 calculates a new anomaly metric value for each anomaly category based on the new internal observation data 230 and determines which bin each anomaly metric value goes in for each histogram. Those anomaly metric values that correspond to normal bins are considered normal, and those anomaly metric values that correspond to anomalous bins are considered anomalous. In this way, the system 100, 200 determines whether each of the anomaly metric values is normal or anomalous.

The fusing of anomalies in multiple categories 240 involves taking the results of the operation of detecting anomalies in each anomaly detection category for the new time period 235 and providing a fused anomaly result that provides an indication of whether the power-usage data of the new time period in general should be considered anomalous, and if so, to what degree. Specifically, this operation involves taking the anomaly results in the current time period for all of the anomaly categories and using that information to determine whether the data in that time period is anomalous.

One way to determine whether or not the power-usage data in the current time period is anomalous is to use counted ruling in which the system 100, 200 provides an anomaly count indicating how many of the anomaly categories are anomalous. The resulting fused anomaly value indicates the degree to which the energy-usage data in the current time period is anomalous by the magnitude of the fused anomaly value. The greater the fused anomaly value, the more likely that the energy-usage data in the current time period is anomalous.

In one embodiment the operation 240 can use a totaled anomaly result and compare that anomaly total to a threshold for anomalous results. For example, an anomalous result for an anomaly category could give a value of 1, while a normal result for an anomaly category could give a value of 0. Different values for normal/anomalous results could be selected for different embodiments. The values for all of the anomaly categories are then totaled and the sum is compared to a threshold value.

For example, in a system with N anomaly categories the anomaly threshold could be (N/2) +1, rounded down (i.e., a simple majority ruling requiring a majority of anomalies from among the anomaly categories); in other embodiments the required threshold could be greater or lower than this value. For example, in another embodiment the system, 100, 200 could require 10% of the categories to be considered anomalous for the energy-usage data in the current time period to be considered anomalous. Other threshold values are possible.

Another way to determine whether or not the power-usage data in the current time period is anomalous is to use weighted ruling in which the system 100, 200 weights the various anomaly categories and generates a sum based on whether each anomaly category is considered anomalous or not. Preferably the weights are arranged to all sum up to one. Each anomaly category that is considered normal (i.e., not anomalous) is given a value of (−1) multiplied by the weight assigned to that anomaly category. Each anomaly category that is considered anomalous is given a value of 1 multiplied by the weight assigned to that anomaly category. The weighted values are then added together for all of the anomaly categories and the result is compared against a threshold value to determine whether or not the power-usage data for the current time period is anomalous. If the resulting sum of weighted values is below the threshold, then the power-usage data for the current time period is considered normal (i.e., not anomalous); if the sum of weighted values is not below the threshold, then the power-usage data for the current time period is considered anomalous.

Under weighted majority ruling, the threshold is set to be zero. However alternate embodiments of weighted ruling can use a value higher or lower than zero for the threshold.

The counted ruling or weighted ruling can also be used to give a more graduated anomaly indication by omitting the anomaly determination and instead identifying the resulting value. For example, when using counted ruling, rather than comparing the total sum of the values for the anomaly categories, the sum itself is provided to the user. Consider if there are five anomaly categories. Rather than set a threshold (e.g., 3) and say that any sum greater than or equal to the threshold indicates an anomalous power-usage data set for the day and any sum less than the threshold indicates a normal power-usage data set for the time period, the sum could indicate the degree to which the power-usage data for the time period is anomalous. A sum of 0 would indicate that the data was not anomalous at all, a sum of 3 would indicate that the data was only just anomalous, and a sum of 5 would indicate that the data was very anomalous, etc.

Similarly, when using weighted ruling, rather than comparing the sum of the weights to a threshold, the sum itself is provided to the user. In the case of a weighted ruling, the resulting sum will vary between −1 (perfectly normal) to 1 (very anomalous). A sum of −1 would indicate that the data was not anomalous at all, a sum of 0 would indicate that the data was only just anomalous, and a sum of 1 would indicate that the data was very anomalous, etc.

By having a sum provided instead of a simple yes/no decision as to whether the power-usage data for the time period was anomalous, the user can receive greater information that can assist in making decisions regarding how to proceed. For example, if the user using counted ruling received three indications of anomalous data for three different time periods, but two had a sum of 3 and one had a sum of 5, the user might wish to prioritize examining the time period that had the higher sum, since its causes for being considered anomalous were greater.

This can increase the efficiency of the system by providing more information to the user, allowing the user to make more informed decisions. In doing this, it is possible to increase the efficiency of the entire system.

In addition, this operation 240 may also involve analyzing the anomaly results such that results that are correlated with each other are not double counted. The system 100, 200 can identify “principal” latent anomaly metrics using well-known techniques such as principal component analysis (PCA) or singular value decomposition (SVD) and use that information to make a better decision regarding whether or not the energy-usage data for the current time period is anomalous.

The benefit of this additional step is as follows. PCA converts a set of observations of possibly correlated variables into a set of values of linearly uncorrelated variables called principal components. In this process, when N latent variables are produced, some of these variables may be strongly correlated. PCA operates to separate those correlated metrics out. Otherwise, when fusing individual metrics' anomaly detection results to determine the overall anomaly level of a time period, these multiple correlated anomaly metrics would change their states together, and hence bias the detection result. In this way, the value of N used for determining the threshold would be varied to account for only the anomaly categories considered.

For example, assume that there are five anomaly metrics (a1, a2, a3, a4, a5) and three of them (a3, a4, a5) are strongly correlated. Also, assume that majority ruling is used for fusing information from these five metrics. If {a1, a2}=0 and {a3, a4, a5}=1 for a given time period (with 0 indicating a normal value and 1 indicating an anomalous value), the system 100, 200 would conclude that the subject time period was anomalous using majority ruling and not using PCA (N=5, (N/2)+1=3, 3 anomalous values ≥3).

However, if PCA was used prior to the majority ruling, only one of the correlated metrics would contribute to the decision. Since {a3, a4, a5} are all strongly correlated, only one of these anomaly metrics (e.g., a3) would be counted in the calculation. With {a1, a2}=0 and {a3}=1, the system 100, 200 would then conclude that the subject day was normal (N=3, (N/2)+1=2, 1 anomalous value <2).

A similar process could be used if weighted ruling was used. However, when the number of principal latent anomaly metrics is smaller than the number of total latent anomaly metrics, it is necessary to adjust the weights to account for the removed values. Specifically, the weights of the principal latent anomaly metrics must be normalized to one so that the weighting process will perform properly.

The use of SVD provides a similar benefit to that shown above for PCA.

The visualizing of anomalies overlaid in anomaly histograms and anomalous time periods 245 involves providing the results of the anomaly detection operation 235 and anomaly fusing operation 240 to a display so that a user can visually observe the results. In such an operation, a user can select an individual time period and display any or all of the histograms associated with the available anomaly categories. If an anomaly category has been identified as having anomalous data for the selected time period, the corresponding histogram will have a specific indicator identifying the anomaly.

In addition, the display for the selected time period will also provide an indication as to whether the power-usage data for that selected time period is anomalous or not in general. This anomaly indication data could be a simple yes/no indicator identifying the data as either normal or anomalous, or it could be a gradated indicator providing additional information as to the degree to which the power-usage data for the time period is or is not anomalous.

For example, the display could list the word “normal” or the word “anomalous” for each time period, it could identify a number of anomaly categories for that time period that have been identified as anomalous, or it could provide a weighted sum between −1 and 1 indicating the degree to which the various anomaly categories have been identified as anomalous or normal.

The updating of the anomaly model 250 involves updating the anomaly model (i.e. the histograms) based on the new interval observation data 230. In one embodiment, the new internal observational data 230 is added to the historical utility data 205 to create a new set of histograms for each anomaly category based on the total data collected. For example, if the initial historical utility data 205 contained data for 1096 time periods, then when the next new interval observation data 230 was gathered, the updating operation 250 would involve adding the 1097^{th} set of data to the 1096 previous data entries and recalculating the histograms using 1097 data entries. As each new interval observation data 230 was added, the number of sets of data used to generate the anomaly model will increase. In this way, after 1000 sets of new interval observation data 230 have been received, the anomaly model will be calculated using 2096 sets of data.

In the alternative, a set window of data values could be used, with each set of new interval observation data 230 causing the oldest set of data used to calculate the anomaly model to drop away. In one such embodiment the data window is 1096 entries wide. In this embodiment, the historical utility data 205 initially contains 1096 entries. After the system 100, 200 receives the new interval observation data 230 and the system 100, 200 proceeds to update the anomaly model, the first entry in 1096 stored data entries will be dropped and the newly received 1097^{th} entry will be added. In this way, for the next time period that the system 100, 200 receives new internal observation data, the anomaly model will be built using the second through 1097^{th} sets of data. Likewise, after 1000 sets of new interval observation data 230 have been received, the anomaly model will be calculated using the 1001^{st} through 2096^{th} sets of data (i.e., there will still be only 1096 data sets used to calculate the anomaly model). In this way, the system 100, 200 can focus on data for recent time periods, which could be considered more accurate in some embodiments.

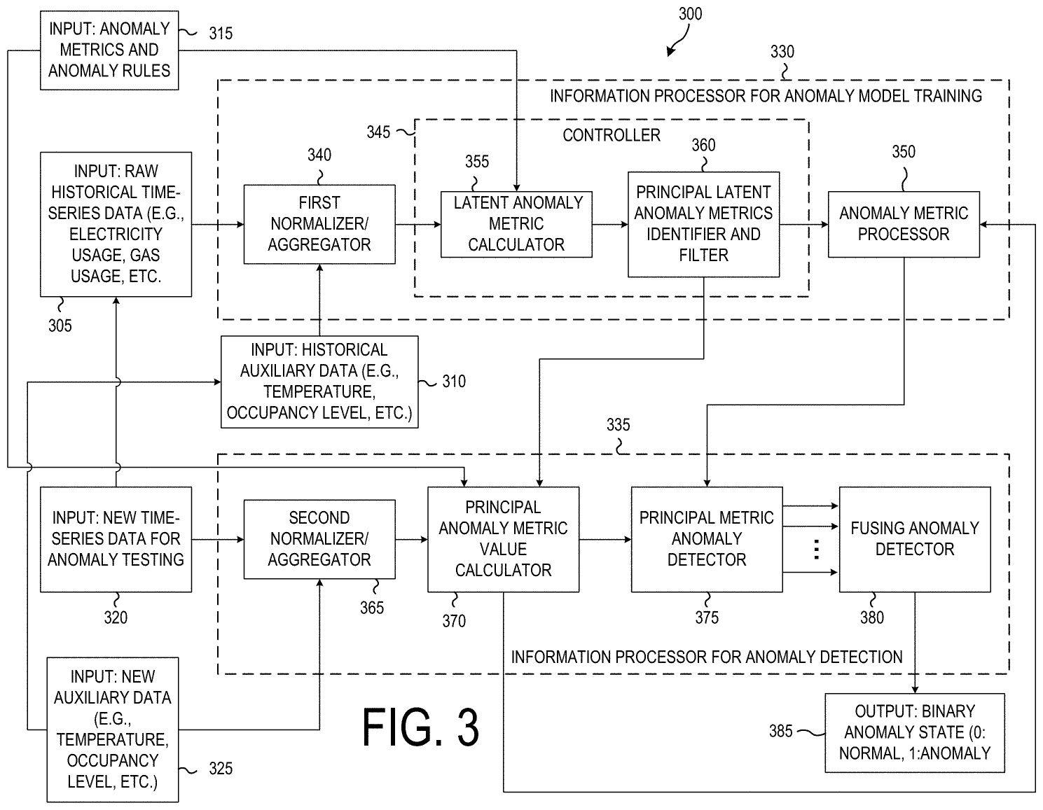

FIG. 3 is a block diagram of a system 300 for actuating the process 200 of FIG. 2 for automatically detecting anomalies in a power-usage data set according to a disclosed embodiment.

As shown in FIG. 3, the process 300 includes five inputs and provides one output. The inputs are: raw historical time-series data 305, historical auxiliary data 310, anomaly metrics and anomaly rules 315, new time-series data for anomaly testing 320, and new auxiliary data 325. The output is an output binary anomaly state 385. The system 300 includes an information processor for anomaly model training 330 and an information processor for anomaly detection 335. The information processor for anomaly model training 330 includes a first normalizer/aggregator 340, a controller 345, and an anomaly metric processor 350. The controller 345 includes a latent anomaly metric calculator 355 and a principle latent anomaly metric identifier and filter 360. The information processor for anomaly detection 335 includes a second normalizer/aggregator 365, a principal anomaly metric value calculator 370, a principal metric anomaly detector 375, and a fusing anomaly detector 380.

The raw historical time-series data 305 includes a set of data regarding energy usage for a building (e.g., electricity usage, gas usage, etc.) for a plurality of previous time periods. These can be a set of immediately previous time periods or could be a non-contiguous prior set of time periods (e.g., every other previous time period). In one disclosed embodiment the raw historical time-series data is for a set of 24-hour periods (i.e., days) at a 15-minute resolution, though the time period and the resolution could be different in alternate embodiments.

The historical auxiliary data 310 includes data relevant to anomaly detection but not related to energy usage (e.g., temperature data, precipitation data, occupancy data, etc.) for the plurality of previous time periods.

The anomaly metrics and anomaly rules 315 is a set of formulas and rules that are used to categorize the raw historical time-series data 305 and determine what entries in the raw historical time-series data 305 are anomalous. The anomaly metrics include a plurality of formulas that can be applied to aggregated and normalized data to calculate a plurality of anomaly metric values that correspond to each of the various anomaly metrics. These could include peak power demand, total power usage, mean power usage, etc. The anomaly rules include the various rules that are used to create the anomaly model (i.e., the histograms) and to determine whether a given anomaly metric value is normal or anomalous. These could include a number of bins to be used in each histogram, an anomaly level threshold to determine which bins correspond to anomalous results, etc.

The new time-series data for anomaly testing 320 includes a set of data regarding energy usage for a previous time period subsequent to the last entry in the raw historical time-series data 305. In one embodiment the new time-series data for anomaly testing 320 is from an immediately previous time period, and the raw historical time-series data 305 includes data relating to a time periods prior to the immediately previous time period. For example, the new time-series data for anomaly testing 320 could be power-usage data for the immediately prior day, while the raw historical time-series data 305 could be power-usage data for a certain number of days before the immediately prior day.

The new auxiliary data 325 includes data relevant to anomaly detection but not related to energy usage (e.g., temperature data, precipitation data, occupancy data, etc.) for the previous time period subsequent to the last entry in the new time-series data 320.

In one embodiment, the raw historical time-series data 305 includes power-usage data for 1096 days prior to the most recent day, and the new time-series data 320 includes power-usage data for the most recent day. Similarly, the historical auxiliary data 310 includes auxiliary data for 1096 days prior to the most recent day, and the new auxiliary data 325 includes power-usage data for the most recent day.

The number of time periods worth of data stored in the raw historical time-series data 305 and the historical auxiliary data 310 can vary in alternate embodiments. A useful range might be between 90 and 1500 days, though any suitable range can be used. Preferably the time period of stored data will be at least three months (i.e., 90 days). In fact, if the system 300 has been in operation for a long time, the raw historical time-series data 305 and the historical auxiliary data 310 may become quite large.

The new time-series data 320 can be connected to the raw historical time-series data 305, since as time progresses and the system moves onto a next time period, what is currently the new time-series data 320 is added to the raw historical time-series data 305 and a new set of new time-series data 320 is acquired for the new time period.

Similarly, the new auxiliary data 325 can be connected to the historical auxiliary data 310, since as time progresses and the system moves onto a next time period, what is currently the new auxiliary data 325 is added to the historical auxiliary data 310 and a new set of new auxiliary data 325 is acquired for the new time period.

The information processor for anomaly model training 330 operates to build an anomaly model based on the raw historical time-series data 305 and the historical auxiliary data 310. This anomaly model can include a plurality of histograms, one for each of a plurality of anomaly categories, as described above.

The information processor for anomaly detection 335 operates to determine whether all or part of the new time-series data is anomalous. It makes this determination based in part on the anomaly model and the anomaly rules 315, as set forth above.

The first normalizer/aggregator 340 operates to aggregate the raw historical time-series data and the historical auxiliary data and then normalize the raw historical time-series data based on factors such as past temperature, precipitation, and/or building occupancy. The first normalizer/aggregator 340 may be omitted in some embodiments.

The controller 345 operates to calculate a plurality of latent anomaly metrics, identify a set of principle latent anomaly metrics, and filter the principle latent anomaly metrics.

The anomaly metric processor 350 operates to build/update the anomaly model based on the normalized raw historical time-series data 305. In one embodiment, the processor 350 creates a plurality of histograms, one for each principle anomaly metric. Each histogram includes a number of entries equal to the number of sets of power-usage data in the raw historical time-series data.

The latent anomaly metric calculator 355 operates to calculate a set of latent anomaly metrics based on the raw historical time-series data 305 and the anomaly metrics. There will be one latent anomaly metric for each identified anomaly metric in the historical auxiliary data.

The principle latent anomaly metric identifier and filter 360 operates to identify a set of principle latent anomaly metrics based on the latent anomaly metrics and how greatly they correlate with each other. The principle latent anomaly metrics is a set of anomaly metrics that can include all or some of the latent anomaly metrics. Certain latent anomaly metrics may be filtered out of the set of latent anomaly metrics based on a set of filtering rules contained in the principle latent anomaly metric identifier and filter 360.

The principle latent anomaly metric identifier and filter 360 includes a set of rules that determines when two latent anomaly metrics are too closely correlated, and if so, which latent anomaly metric should be discarded and which latent anomaly metric should be set as a principle latent anomaly metric. In one embodiment, the rule for determining which of two closely correlated latent anomaly metrics to use as a principal latent anomaly metric is to select as a principal latent anomaly metric the latent anomaly metric that shows the least correlation with the other principal latent anomaly metrics. However, other rules can be used in alternate embodiments. Any latent anomaly metric that is not closely correlated with another latent anomaly metric will generally be set to be a principle latent anomaly metric.

The second normalizer/aggregator 365 operates to aggregate the new time-series data and the new auxiliary data and then normalize the new time-series data based on factors such as temperature, precipitation, and/or building occupancy. The second normalizer/aggregator 360 may be omitted in some embodiments.

The principal anomaly metric value calculator 370 operates to determine an anomaly metric value for each anomaly category based on the normalized and aggregated data derived from the new time-series data 320 and the new auxiliary data 325 using the anomaly metrics and anomaly rules. It operates using the same anomaly metrics and anomaly rules as were used in the latent anomaly metric calculator 355 to determine anomaly metric values based on the normalized and aggregated data derived from the raw historical time-series data 305 and the historical auxiliary data 310.

The principal anomaly metric value calculator 370 can then assign each newly calculated anomaly metric value to a bin in the histogram associated with the corresponding anomaly category.

The principal metric anomaly detector 375 operates to detect whether there is an anomaly in each metric dimension for each of the principle anomaly metrics. Thus, the principal metric anomaly detector 375 must be designed to potentially detect whether there is an anomaly in all of the latent anomaly metrics, since in some situations all of the latent anomaly metrics will be determined to be principle anomaly metrics.

The principal metric anomaly detector 375 makes the determination of whether or not there is an anomaly in each of the principal anomaly metrics by analyzing the histogram associated with each principal anomaly metric in association with an anomaly level threshold associated with that histogram. As noted above, the anomaly level threshold identifies a number of bins in the histogram that represent anomalous values. If an anomaly metric value calculated from the new time-series data falls into one of the anomalous bins for a given principal anomaly metric, then that metric value is considered anomalous; if the anomaly metric value calculated from the new time-series data falls into one of the normal bins for the given principal anomaly metric, then that metric value is considered normal.

The principal metric anomaly detector 375 outputs a plurality of values, one for each of the principal anomaly metrics. Each output value indicates whether or not that principal anomaly metric value is anomalous.

The fusing anomaly detector 380 receives the plurality of signals that indicate whether or not each principal anomaly metric value is anomalous from the principal metric anomaly detector 375, and uses that information to determine whether or not the time period associated with the new time-series data 320 is anomalous. As noted above, this determination can be used by counted ruling or weighted ruling. In other words, the fusing anomaly detector 380 can calculate a sum based on the total number of principal anomaly metrics that are considered anomalous, or it can create a sum based on a weight given to each of the principal anomaly metrics, with normal principal anomaly metrics being negative and anomalous principal anomaly metrics being positive. Either of these sums is then compared to an appropriate threshold to determine whether or not the time period associated with the new time-series data is anomalous.

The output binary anomaly state 385 indicates whether or not the time period associated with the new time-series data is anomalous. In one embodiment the output binary anomalous state 385 is either a 1 or a 0. If the output binary anomalous state 385 is a 1, the time period associated with the new time-series data is anomalous; if the output binary anomalous state 385 is a 0, the time period associated with the new time-series data is normal. Alternate embodiments can use different values to indicate whether or not the time period associated with the new time-series data is anomalous.

As noted above, however, in alternate embodiments, the output binary anomaly state 385 can be replaced with an indicator showing the value calculated by the fusing anomaly detector 380, without converting it to an output binary anomaly state, i.e., without using the value to determine whether or not the time period associated with the new time-series data is anomalous. In such an embodiment, the output of the fusing anomaly detector will be a sum of values generated from the plurality of signals that indicate whether or not each principal anomaly metric value is anomalous from the principal metric anomaly detector 375. This sum will provide a gradated indication of how serious any anomaly is in the period associated with the new time-series data.

Anomaly Metrics

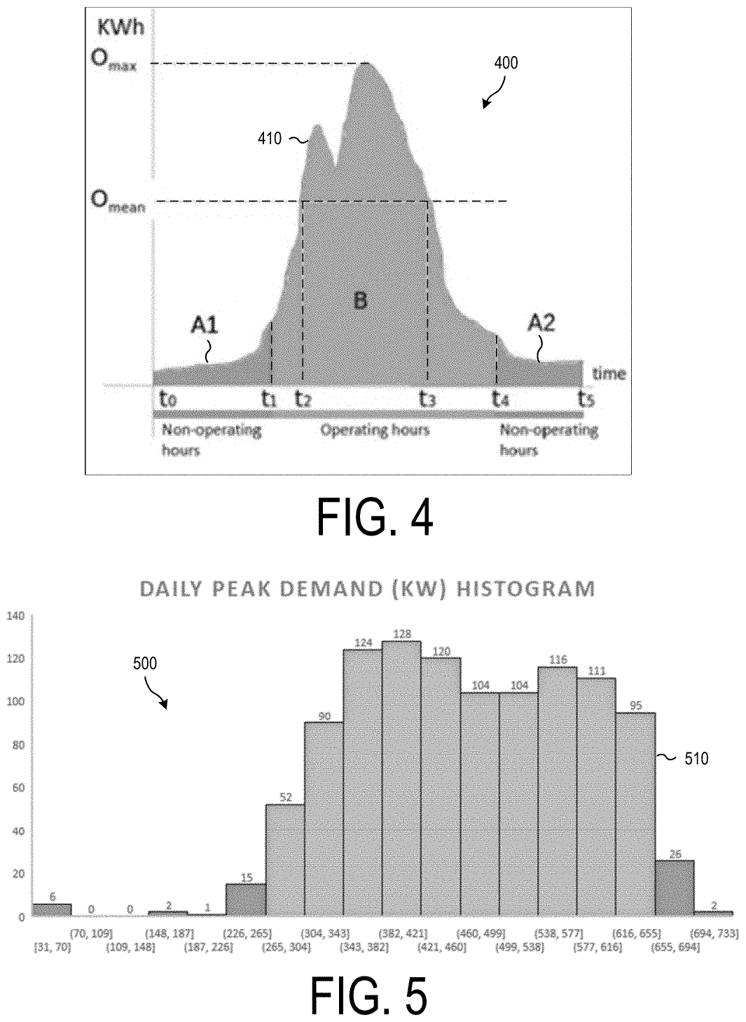

FIG. 4 is a graph 400 of power usage over time for a building according to a disclosed embodiment. This is representative of some of the historical utility data 210/historical daily time-series data 305 used to determine anomaly data. As shown in FIG. 4, the graph 400 identifies power usage for a period from time to t₀ time t₅. This time period may be a single day, having to be 12:00 am at the beginning of the day and t₅ be 12:00 am at the end of the day. However, this is by way of example only. Other time periods can be used in alternated embodiments.

In FIG. 4, a maximum energy usage Oₘₐₓ during the time period can be shown, and an average energy usage Oₘₑₐₙ over the course of the time period can be shown.

The graph 400 of FIG. 4 assumes that the target building will be in a non-operating mode during part of the day and in an operating mode during another part of the day. The operating mode corresponds to a time when the building is expected to have comparatively greater occupancy and energy usage, while the non-operating mode corresponds to a time when the building is expected to have comparatively lesser occupancy and energy usage. In one embodiment, the operating mode takes place during regular working hours (e.g., 9 am-6 pm) while the non-operating mode takes place during non-working hours (e.g., 6 pm-9 am). In such an embodiment it is assumed that energy usage for such things as air-conditioning, lights, elevators, and computers will be increased during working hours and decreased during non-working hours. However, this is by way of example only. Alternate embodiments can set the operating and non-operating modes as desired. For example, a building may have some machinery that sees greatest use during a particular time of day. In that case, the time of expected greatest use could be set as the operating mode, and the time of expected least use could be set as the non-operating mode.

In FIG. 4, the time ti represents the beginning of the operating mode, and the time t₄ represents the end of the operating mode. As shown in the power graph 400, the period of greatest power usage is between times t₁ and L₁.

Time t₂ represents the time at which power consumption in the building first reaches the average power consumption Oₘₑₐₙ after the start of the operating mode t₁. Time t₃ represents the last time that the building maintains at least the average power consumption Oₘₑₐₙ before the end of the operating mode t₄. Times t₀, t₁, t₄, and t₅ are set by a user, while times t₂ and t₃ are calculated based on the power-usage data.

The energy-usage graph 400 is generated at the end of the set time period (e.g., 24-hour period). This allows for the determination of the average power consumption Oₘₑₐₙ and the times t₂ and t₃. Since the average power consumption Oₘₑₐₙ cannot be determined until all of the data is gathered for the time period, it is impossible to generate the energy-usage graph 400 until the end of the time period. The historical utility data 210/raw historical daily time-series data 305 will preferably contain an energy usage graph 400 for each time period (e.g., one energy-usage graph 400 for each day).

The processor 150 and the anomaly detector 160 can use the plurality of energy-usage graphs 400 to build an anomaly model using a variety of anomaly metrics 205 and anomaly rules 210. Some examples of anomaly metrics are as follows:

1. First non-operating start time (t₀);

2. First non-operating end time/operating start time (t₁);

3. Second non-operating start time/operating end time (t₄);

4. Second non-operating end time (t₅);

5. First non-operating total usage (N₁, t₀≤t<t₁);

6. First non-operating mean usage (N₁ₘₑₐₙ/(t₁−t₂), to ≤t<t₁);

7. Second non-operating total usage (N₂, t₄≤t<t₅);

8. Second non-operating mean usage (N₂ₘₑₐₙ/(t₅−t₄), t₄≤t<t₅);

9. All non-operating usage (Na=N₁+N₂);

10. All non-operating mean usage (Nₘₑₐₙ);

11. Total operating usage (O, t₁≤t≤t₄);

12. Max operating usage (Oₘₐₓ=max[Oi], t₁≤t≤t₄);

13. Peak demand (4*Oₘₐₓ);

14. Mean operating usage (Oₘₑₐₙ=O/tₒₚ, t₁≤t≤t₄);

15. Initial Oₘₑₐₙ crossing time (t₂);

16. Final Oₘₑₐₙ crossing time (t₃);

17. First A usage (A₁, t₀≤t<t₂);

18. First A mean (A₁ₘₑₐₙ/(t₂−t₀), t₀≤t<t₂);

19. Second A usage (A₂, t₃<t≤t₅);

20. Second A mean (A₂ₘₑₐₙ/(t₅−t₃), t₃<t≤t₅);

21. B usage (B, t₂≤t≤t₃);

22. B mean (Bₘₑₐₙ/(t₃−t₂), t₂≤t≤t₃);

These anomaly metrics are by way of example only. More or fewer metrics can be used in various embodiments.

The calculation of latent anomaly metrics 350 involves calculating a metric value for each metric for each set time period (e.g., one metric value for each metric each day). The operation of calculating latent anomaly metrics 350 proceeds for a set number of times (e.g., between 700-1400 times) representing a number of time periods for which data has been gathered. In one embodiment the time period is a day and the number of initial records is 1096. This represents data for the past 1096 days, or approximately the last three years. Preferably this data is consecutive time periods (e.g., consecutive days), though that is not absolutely necessary.

The system 100, 200, 300 then divides up the possible metric values for a given metric into a number of separate bins of equal width, each bin representing an equal range of values for the metric. For example, one embodiment uses twenty bins. In this embodiment, the number of potential metric values from a minimum measured metric value to a maximum measured metric value are divided up into twenty equally sized bins. The value of each bin is then incremented for each metric values that falls within the range of values defined by that bin. In this way, the system 100, 200, 300 creates a plurality of bins, each of which represents the number of calculated metric values that fall within the range defined by that bin. Alternate embodiments can use a different number of bins as desired.

The system 100, 200, 300 can then display these bins in numerical order and graphically show the number of results in each bin. In this way, the system 100, 200, 300 can create a histogram for the values of each metric.

FIG. 5 is a histogram 500 of daily peak power demand for a building over a set period of time according to a disclosed embodiment.

As shown in FIG. 5, the histogram 500 represents 1096 values of daily peak demand over the course of 1096 consecutive days. The lowest value for daily peak demand is 31 KW, and the highest value of daily peak demand is 733 KW. The histogram contains twenty bins, each representing a range of 39 KW. Each bin 510 is associated with a number that represents the number of the 1096 calculations of peak demand that fall within the range defined by that bin 510.

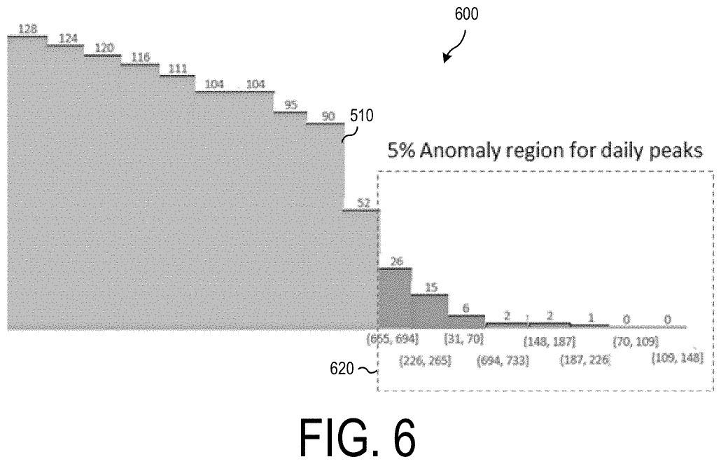

FIG. 6 is the histogram 600 of FIG. 5, sorted from greatest demand to least demand according to a disclosed embodiment.

As shown in FIG. 6, the histogram 600 has the bins 510 with the greatest values arranged to the left, and the bins 510 with the lowest values arranged to the right, with the bin sizes decreasing from highest to lowest as they pass from left to right.

The system 100, 200, 300 then defines an anomaly region 620 for the histogram 600 based on information from the anomaly rules 220. This anomaly region 620 includes a certain number of bins with the lowest values. According to one embodiment, the anomaly rules 220 include an anomaly level threshold that is a percentage (e.g. 1%, 5%, etc.) of the total metric values which will define the anomaly region 620. The anomaly region is defined as the lowest bins whose values do not exceed the percentage of total metric values.

For example, in the embodiment of FIG. 6, there are 1096 total metric values, and the anomaly level threshold is set to be 5%. Calculating 5% of 1096 gives a result of 54.8 total values (which may be rounded down to 54 or rounded up to 55, as desired). As a result, the anomaly region 620 is therefore defined as the set of the lowest value bins whose total values don't exceed 54 (assuming rounding down). FIG. 6 shows that the eight lowest value bins have a total value of 52, which is lower than 54. The ninth lowest value bin has a value of 52, which, if added to the previous eight bins, would give a value of 104, which is higher than 54. Therefore, the anomaly region 620 is defined as the eight lowest value bins.

The system 100, 200, 300 will create a histogram 500 and calculate an anomaly region 620 for each metric that is used by the system 100, 200, 300. These anomaly regions 620 will then be used to determine whether or not a future value is defined as an anomaly or not. If the future value falls into a bin that is in the anomaly region 620, then the value is considered an anomaly. If the future value falls into a bin that is not in the anomaly region 620, then the value is considered to be a normal value (i.e., not an anomaly).

As each new value is calculated at the end of a new time period (e.g., at the end of a new day), the system 100, 200, 300 will update the anomaly model (i.e., the histograms) based on the new data received. For example, consider the example of when the historical utility data originally contains 1096 values for a given metric representing the metric values for 1096 consecutive time periods. When a 1097^{th} metric value is calculated for a 1097^{th} time period, the system 100, 200, 300 will determine whether the 1097^{th} metric value is an anomaly based on an anomaly model using the original 1096 metric values.

Once this determination is made, however, the anomaly model is updated to represent values from the 1097 calculated metric values, and both the histogram 500 and the anomaly region 620 are updated based on the inclusion of the 1097^{th} metric value. This will be done for each new metric value that it added. In this way, the anomaly model can be constantly refined.

In an alternate embodiment, however, the system 100, 200, 300 can use a rolling window to determine the anomaly model (i.e., the histograms 500 and anomaly regions 620). For example, the system 100, 200, 300 might use a window of the latest 1096 values to create the anomaly model. Thus, when a 1097^{th} metric value is calculated, the system 100, 200, 300 would recalculate the histograms 500 and anomaly regions 620 based on the second through 1097^{th} metric values, dropping the first metric value from the calculation. Similarly, the second metric value would be dropped when a 1098^{th} metric value was added, and so forth. In this way, the histograms 500 would always be made up of the most recent 1096 metric values.

User Interface

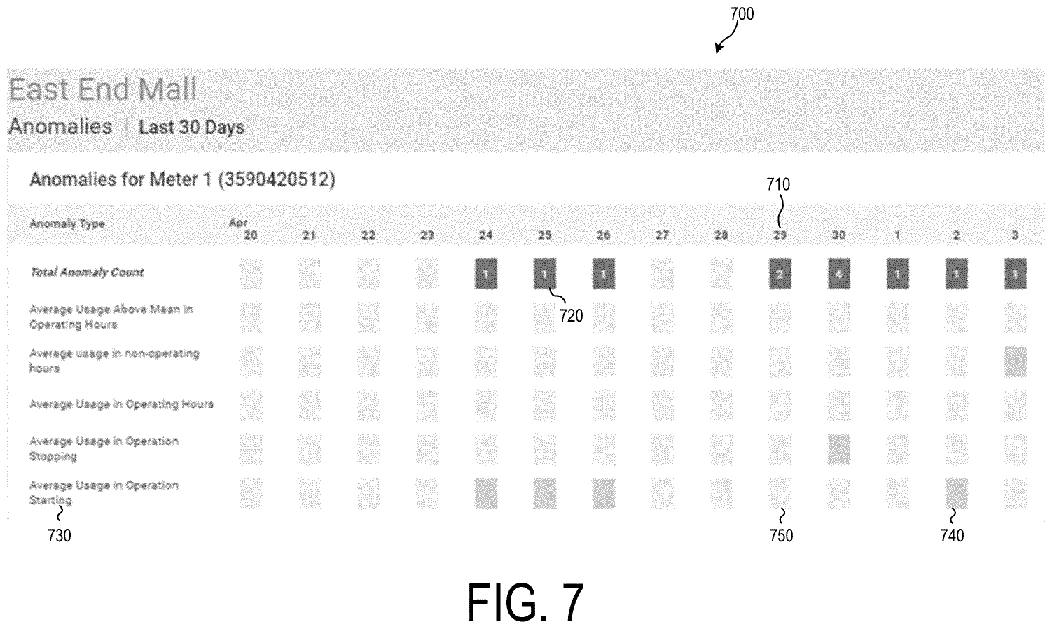

FIG. 7 is an example of a first portion 700 of a user interface identifying anomalies in a power-usage data set by day over a period of days according to a disclosed embodiment.

As shown in FIG. 7, the first portion 700 of the user interface includes a plurality of day indicators 710, an indication 720 of the total number of anomalies associated with each day, a plurality of anomaly category identifiers 730 based on a plurality of anomaly metrics, a plurality of dark-colored blocks 740 indicating the presence of an anomaly in a given anomaly category identifier 730, and a plurality of light-colored blocks 750 indicating the absence of an anomaly in a given anomaly category identifier 730.

The plurality of day indicators 710 are set forth in a line near the top of the first portion 700 and identify the entries in the column below a given day indicator 710 as being associated with the day represented by the day indicator. Although FIG. 7 discloses an embodiment that uses day indicators 710, these indicators could identify a different time period in alternate embodiments.

Although only fourteen day indicators 710 are shown on the first portion 700 of the user interface at any given time, the interface of the first portion 700 allows a user to scroll to the right and left to display the day indicators 710 and associated data relating to any of the days for which data is stored.

The indication 720 identifies the total number of anomalies associated with the day associated with the day indicator 710 at the top of the column. This indication 720 represents a sum calculated using counted ruling, in which the total number of anomalies shown represents a fused value indicative of the strength of any anomaly associated with a given day indicator 710.

In alternate embodiments, the indication 720 could be replaced with a simple binary anomaly state indicator indicating whether or not the data associated with a given day indicator 710 is considered anomalous or not. Alternatively, the indication 720 could be replaced with a weighted value calculated using weighted ruling.

The plurality of anomaly category identifiers 730 identify each of the possible anomaly metrics for which an anomaly metric value can be calculated. Although only five anomaly category identifiers 730 are displayed on the first portion 700 of the user interface at any given time, the interface of the first portion 700 allows a user to scroll up and down to display any of the available anomaly category identifiers 730 and associated data.

The plurality of dark-colored blocks 740 each indicate the presence of an anomaly associated with a given anomaly category identifiers 730 that identifies the row that the dark-colored block 740 is in.

By cross-referencing the anomaly category identifier 730 and the day indicator 710 associated with a given dark-colored block 740, it is possible to determine what day and what anomaly category has been identified as having an anomaly.

The plurality of light-colored blocks 750 each indicate the absence of an anomaly associated with a given anomaly category identifier 730 that identifies the row that the light-colored block 750 is in.

By cross-referencing the anomaly category identifier 730 and the day indicator 710 associated with a given light-colored block 750, it is possible to determine what day and what anomaly category has been identified as not having an anomaly.

Each column represents the time-series data associated with an appropriate number of time periods prior to the time period identified by the associated day indicator 710. In some embodiments this time-series data will represent all of the possible time periods prior to the time period associated identified by the associated day indicator 710. In other embodiments, the time-series data will represent a window of a set width of possible time periods prior to the time period identified by the associated day indicator 710.

By displaying the anomaly information in this manner, the disclosed system improves the ability of a user to identify anomalies and thereby improves the efficiency of the anomaly detection operation and device.

In embodiments in which the latent anomaly metrics are filtered into a set of principal latent anomaly metrics, a latent anomaly metric that has been filtered out of the principal latent anomaly metrics can either be represented by a light-colored block 750 for the day indicator 710 associated with the day for which the latent anomaly metric has been removed. In the alternative, a third type of block could be provided (e.g., a black block) to indicate that that particular latent anomaly metric is not being considered for that particular day indicator 710.

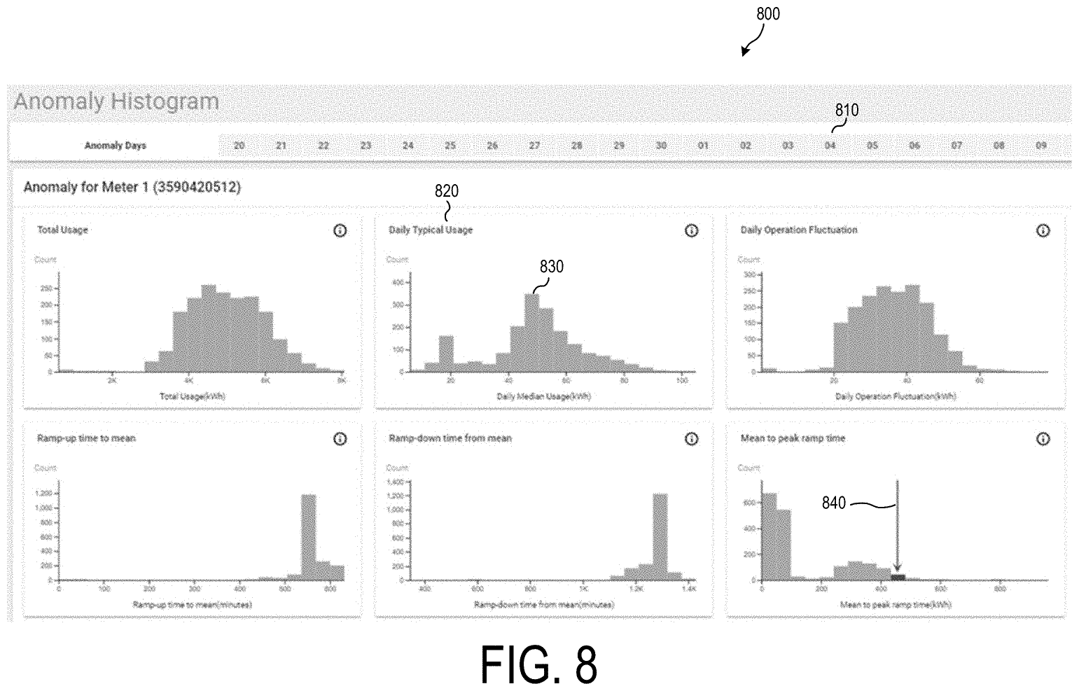

FIG. 8 is an example of a second portion 800 of a user interface identifying anomalies in a power-usage data set by day over a period of days according to a disclosed embodiment.

As shown in FIG. 8, the second portion 800 of the user interface includes a plurality of day indicators 810, a plurality of anomaly category identifiers 820, a plurality of histograms 830, and one or more anomaly indicators 840.

The plurality of day indicators 810 are set forth in a line near the top of the second portion 800 and identify the entries in the column below a given day indicator 810 as being associated with the day represented by the day indicator. Although FIG. 8 discloses an embodiment that uses day indicators 810, these indicators could identify a different time period in alternate embodiments.

The plurality of anomaly category identifiers 820 identify each of the possible anomaly metrics for which an anomaly metric value can be calculated. Although only six anomaly category identifiers 820 are displayed on the second portion 800 of the user interface at any given time, the interface of the second portion 800 allows a user to scroll up and down to display any of the available anomaly category identifiers 820 and associated data.

The plurality of histograms 830 include one histogram for each of the anomaly category identifiers 820. In the disclosed embodiment, these histograms 830 are displayed in normal ordering of values. However, in alternate embodiments the histograms 830 could be ordered in descending order of bin values so that anomaly regions can be shown for each histogram 830.

Each histogram 830 represents the time-series data associated with an appropriate number of time periods prior to the time period identified by the associated day indicator 810. In some embodiments this time-series data will represent all of the possible time periods prior to the time period associated identified by the associated day indicator 810. In other embodiments, the time-series data will represent a window of a set width of possible time periods prior to the time period identified by the associated day indicator 810.

In embodiments in which the latent anomaly metrics are filtered into a set of principal latent anomaly metrics, a latent anomaly metric that has been filtered out of the principal latent anomaly metrics can simply be omitted from the display associated with each day indicator 810. In alternate embodiments, all of the latent anomaly metrics can be displayed for each day indicator 810, but no anomalies will be identified for any latent anomaly metric that has been filtered out of the principal latent anomaly metrics. In yet another embodiment, every latent anomaly metric is displayed for each day indicator 810 and an anomaly indicator 840 is displayed for each latent anomaly metric for which an anomaly has been identified.

The one or more anomaly indicators 840 are provided for each histogram 830 for which an anomaly has been identified. In the disclosed embodiment, the anomaly indicators are made up of a darkened bin representing the bin that the new data would fall in and a dark arrow pointing toward that bin. However, this is by way of example only. Alternate embodiments can use any desirable way of identifying an anomaly with an associated histogram 830.

By displaying the anomaly information in this manner, the disclosed system improves the ability of a user to identify anomalies and thereby improves the efficiency of the anomaly detection operation and device.

Method of Operation

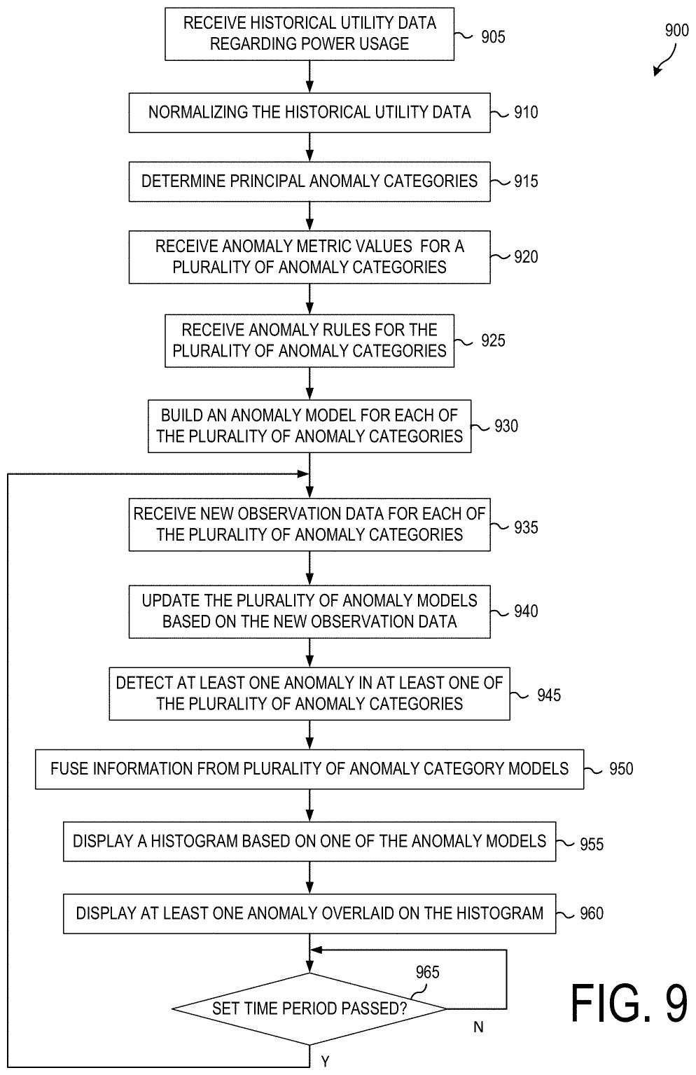

FIG. 9 is a flow chart 900 of a process for automatically detecting anomalies in a power-usage data set according to a disclosed embodiment.

As shown in FIG. 9, operation begins when a process receives historical utility data regarding power usage 905. This historical utility data includes historical time-series data (relating to power usage), and auxiliary data (related to temperature, occupancy level, etc.). The historical utility data includes information for a plurality of prior time periods. In the disclosed embodiment, the time period is one day and the historical utility data includes at least information relating to 1096 days, though this is by way of example only.

The process then normalizes the historical utility data 910 (aggregating it as necessary). This normalization process uses temperature data, precipitation data, occupancy data, etc. to normalize the power-usage data within the historical utility data with respect to the normalization factors. This allows a user to focus on more important causes for anomalies

The process then determines a plurality of principal anomaly categories 915 based on a set of anomaly metrics and anomaly rules. This process can involve calculating an anomaly metric value for each of a plurality of anomaly metrics, determining whether any of the anomaly metric values are strongly correlated with each other, and filtering out anomaly metric values such that only one anomaly metric value is selected for any group of strongly correlated anomaly metric values.

In the disclosed embodiment, when two or more anomaly metric values are strongly correlated, the process filters out those anomaly metric values that are most strongly correlated with other anomaly metric values. This leaves the anomaly metric value that is least correlated with the remaining anomaly metric values.

As a result, the list of principal anomaly categories may be smaller than the list of total anomaly categories. In alternate embodiments, the filtering of anomaly categories can be omitted and this step can involve simply determining anomaly metric values for each of the plurality of anomaly metrics.

The determination of principal anomaly categories is performed for each time period for which the historical utility data includes information. For example, if the historical utility data includes information on 1096 days, the operation of determining principal anomaly categories will determine a set of principal anomaly categories for each of the 1096 days.

The process then receives a set of anomaly metric values for a plurality of anomaly categories 920. These anomaly categories are the principal anomaly categories. Again, the processor receives a respective set of anomaly metric values for each time period for which the historical utility data has information.

The process than receives a plurality of anomaly rules associated with the plurality of anomaly categories 925. These rules include information necessary for creating an anomaly model and determining whether an anomaly exists in each set of principal anomaly categories. For example, the anomaly rules may include a number of bins used for generating histograms, or an anomaly level threshold used for determining the presence of anomaly data within a histogram.

The process than builds an anomaly model for each of the plurality of anomaly categories 930 based on the anomaly metric values, and the anomaly rules. In the disclosed embodiments, this anomaly model is formed by a plurality of histograms, one each for the plurality of anomaly categories, generated as set forth above. A set of histograms are generated in this manner containing data from every time period for which the historical utility data has information.

As noted above, each histogram will have a plurality of bins representing a range of values, and each bin will have a number associated with it indicative of the number of anomaly metric values that fall within the range of values associated with that bin. A certain number of the bins will be designated as being anomalous, and any future anomaly metric value that falls into one of those bins will also be considered anomalous.

In the disclosed embodiment, histograms are generated for each of the principal anomaly categories, since the total set of anomaly categories has been filtered down to a set of principal anomaly categories. In alternate embodiments, however, the filtering can be done at a later time, and the building of the anomaly model can involve generating histograms for every anomaly category for every time period.

Once the anomaly model has been built, the processor receives new observation data for each of the plurality of anomaly categories 935. This new observation data represents the data for an entire time period after the time periods set forth in the historical utility data. In the disclosed embodiment, the new observation data represents data for a most recent day, and the historical utility data represents data for 1096 days prior to the most recent day. However, this is by way of example only, and all that is required is that the new observation data represent a time period after the time periods set forth in the historical utility data.

The process than updates the plurality of anomaly models based on the new observation data 940. This is done by generating new anomaly metric values for each of the anomaly metrics associated with a histogram based on the new observation data, and determining what bins the new anomaly metric values should be placed into.

The process than detects at least one anomaly in at least one of the plurality of anomaly categories 945. This is done by identifying whether a new anomaly metric value should be placed in a bin that has been identified as anomalous based on the plurality of anomaly rules. When a new anomaly metric value is determined to be placed in an anomalous bin, the new anomaly metric value is considered anomalous. When a new anomaly metric value is determined to be placed in a normal bin, the anomaly metric value is considered normal.

The process then fuses information from a plurality of anomaly category models 950 associated with a given time period. This can be accomplished by identifying the plurality of anomaly categories associated with the given time period and either summing the number of anomaly categories for which an anomaly metric value is considered anomalous, or weighting the anomaly metric values based on a series of weighting values and a positive or negative value based on whether or not the anomaly metric values are considered anomalous. A more detailed description of this process is described above.

The resulting fused information can provide an indication as to whether the new time period should be considered anomalous or normal. In some embodiments the fused information will be a yes/no indicator of whether the new time period should be considered anomalous; in other embodiments the fused information will be a value indicative of how severe any anomaly is for the new time period.

A display unit then displays at least one histogram based on at least one of the anomaly models 955. An example of this can be seen in FIG. 8. This at least one histogram will show at least a collection of the anomaly metric values associated with the time periods contained in the historical utility data. In some embodiments it may also include the anomaly metric value associated with the new time period.

The display unit also displays at least one anomaly indicator overlaid on one of the at least one histograms 960. This anomaly indicator will identify the presence of an anomaly in the associated anomaly category from the new observation data for the new time period. An example of this can be seen in FIG. 8.

Since not all new observation data includes anomalies, this operation may be omitted for any set of new observation data that does not include any anomalies.

Finally, the processor checks whether a current time period has passed 965. If the current time period has not passed, the processor continues to wait. However, if the current time period has passed, the processor will return to step 935 to receive a new set of observation data for the time period that has just passed.

In this way, the plurality of anomaly models are continually updated as each time period passes. For example, if the time period is a day, the anomaly models will be updated once each day, as the new observation data for that day is completed.

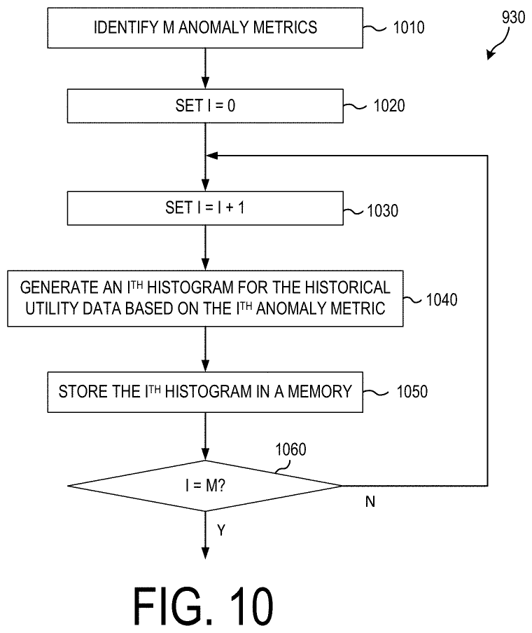

FIG. 10 is a flow chart of an operation of building an anomaly model 930 from FIG. 9 according to a disclosed embodiment.

As shown in FIG. 10, the operation begins by identifying M anomaly metrics 1010. These M anomaly metrics define M anomaly categories that are associated with each set of data for a given time period. In some embodiments in which no filtering is performed on the available anomaly metrics, M is equal to the total number of anomaly categories. In other embodiments in which the available anomaly metrics are filtered down to a set of principal anomaly metrics, M will represent the number of principal anomaly metrics, and may be less than the total number of anomaly categories.

A value for an index variable I is set to be equal to zero 1020. This index value I represents which anomaly metric is currently being considered. As a result, each potential anomaly metric will be identified by a number ranging from 1 to M.

The value for the index variable I is then incremented by one 1030. This advances the process to the next anomaly metric. If I is equal to zero when this step is reached, the index variable I will be set to 1, indicating that the first anomaly metric will be considered.

The process then proceeds to generate an histogram for the historical utility data based on the anomaly metric 1040. The exact process for generating a histogram is described above. In general, it involves breaking up the possible values for the anomaly metric into a plurality of equal-sized bins, calculating anomaly metric values for each of the available time periods, and allocating those anomaly metric values into an appropriate bin. The resulting histogram displays the number of anomaly metric values that have been assigned to each individual bin.

The process then proceeds to store the I^{th} histogram in a memory 1050. This allows the histogram to be accessed at a future date for display on a display device, or for further processing.

Finally, the process determines whether the index value I is equal to M 1060. If the index value I is indeed equal to M, the process continues to the step 935 in the process of FIG. 9. If, however, the index value I is not equal to M, the process returns to step 1030, increments the index value I by one, and continues processing.

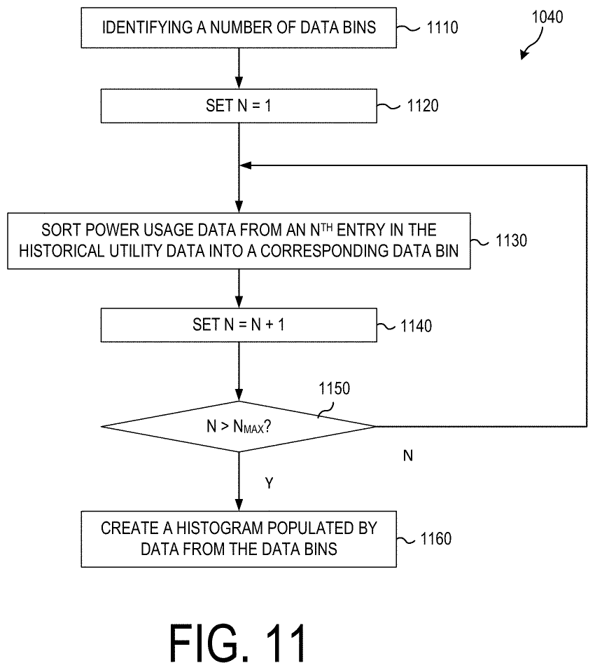

FIG. 11 is a flow chart of an operation of generating a histogram 1040 from FIG. 10 according to a disclosed embodiment.

As shown in FIG. 11, the process begins by identifying a number of data bins that will be used for the histogram 1110. The number of data bins will typically be contained in the anomaly rules set forth for the associated anomaly metrics. In a disclosed embodiment the number of data bins is 20. However, this is by way of example only, and a larger or smaller number of data bins can be used in alternate embodiments.

In the disclosed embodiments, each data bin represents an equal number of possible values for the associated anomaly metric. The number of possible values associated with each data bin can be determined by subtracting the minimum value of the anomaly metric from the maximum value of the anomaly metric and dividing the result by the number of data bins.

The process then sets an index value N to be equal to one 1120. This index value N represents the number of time periods for which data is stored in the historical utility data.

The process then accesses power usage data from an Nth entry in the historical utility data, applies an associated anomaly metric to that power usage data to generate an anomaly metric value, and sorts the resulting anomaly metric value into an appropriate data bin.

The process then increments the index value N by 1 1140. In this way, the process advances to the next time period for which data is stored in the historical utility data.

The process then determines whether the index value N is greater than a value Nₘₐₓ. The value Nₘₐₓ represents a maximum number of the time periods stored in the historical utility data. In the disclosed embodiment, Nₘₐₓ is equal to 1096. However, this is by way of example only. Alternate embodiments can use a different value for Nₘₐₓ. In various embodiments, Nₘₐₓ might vary between 90 and 1500, though higher and lower values are possible.

If the index value N is not greater than the value Nₘₐₓ, then the process returns to step 1130 and processes the next set of power usage data from the next entry in the historical utility data.

If, however the index value N is greater than the value Nₘₐₓ, then the process creates a histogram populated by data from the data bins 1160. In the preferred embodiment, the bins of this histogram are ordered from the lowest range values to the highest range values. However, alternate embodiments can use different orders. For example, the bins of the histogram might be ordered from the highest number of entries in a bin to the lowest number of entries in a bin. This particular example allows for an easier identification of an anomaly region in which the data in the histogram is considered anomalous.

Conclusion

This disclosure is intended to explain how to fashion and use various embodiments in accordance with the invention rather than to limit the true, intended, and fair scope and spirit thereof. The foregoing description is not intended to be exhaustive or to limit the invention to the precise form disclosed. Modifications or variations are possible in light of the above teachings. The embodiment(s) was chosen and described to provide the best illustration of the principles of the invention and its practical application, and to enable one of ordinary skill in the art to utilize the invention in various embodiments and with various modifications as are suited to the particular use contemplated. All such modifications and variations are within the scope of the invention as determined by the appended claims, as may be amended during the pendency of this application for patent, and all equivalents thereof, when interpreted in accordance with the breadth to which they are fairly, legally, and equitably entitled. The various circuits described above can be implemented in discrete circuits or integrated circuits, as desired by implementation.

What is claimed is:

1. A method of detecting anomalies in a power-usage data set, comprising:
receiving historical utility data regarding power usage in a building over a period of time, and storing the historical usage data in a computer memory;
receiving anomaly metrics for a plurality of anomaly categories related to the historical utility data and storing the anomaly metrics in the computer memory;
receiving anomaly rules for the plurality of anomaly categories and storing the anomaly rules in the computer memory;
building an anomaly model for each of the plurality of anomaly categories via a data processor, by transforming the historical utility data into a user-readable format based on the anomaly metrics, the anomaly model including a plurality of corresponding histograms;
receiving interval observation data after building the anomaly model for each of the plurality of anomaly categories, the interval observation data including at least one data entry relating to power usage in the building during a time interval after the period of time, and storing the interval observation data in the computer memory; and
detecting at least one anomaly in at least one of the plurality of anomaly categories via the data processor using the plurality of corresponding histograms, the interval observation data, and the anomaly rules.

2. The method of detecting anomalies in a data set of claim 1, further comprising:
updating the anomaly model for each of the plurality of anomaly categories using the interval observation data.

3. The method of detecting anomalies in a data set of claim 1, further comprising:
normalizing the historical utility data prior to building the anomaly model for each of the plurality of anomaly categories.

4. The method of detecting anomalies in a data set of claim 3, wherein the normalizing of the historical utility data includes at least one of weather normalization and occupancy normalization.

5. The method of detecting anomalies in a data set of claim 1, wherein the plurality of anomaly categories includes at least one of:
an average energy usage for the building above a mean energy usage within a specified operating time on a subject day,
an operational average hourly energy usage for the building during the specified operating time,
a non-operational average hourly energy usage for the building during a time other than the specified operating time on the subject day,
a time interval between a beginning of the specified operating time and a time when an actual energy usage for the building reaches the mean energy usage,
a ratio of total daily energy usage in the building to twenty-four times a daily peak value for energy usage,
a highest daily power load within a set time window during the specified operating time,
a total energy usage in the building for the subject day,
a total energy usage in the building above the mean energy usage for the subject day,
a median daily energy usage in the building on the subject day,
an operating usage variability within the specified operating time,
a non-operating usage variability within the time other than the specified operating time on the subject day, and
a peak operating load during the subject day.

6. The method of detecting anomalies in a data set of claim 1, wherein
the historical utility data includes a plurality of data entries, each corresponding to a different time interval in the period of time, and
each of the plurality of data entries includes one or more pieces of power usage data related to a corresponding different time interval.

7. The method of detecting anomalies in a data set of claim 6, wherein the operation of building the anomaly model includes:
identifying a plurality of data bins, each data bin identifying an equal range of power usage from a minimum power usage among the historical utility data to a maximum power usage among the historical utility data;
sorting each of the plurality of data entries into one of the plurality of data bins corresponding to a power usage associated with the corresponding one of the plurality of data entries;
creating a histogram populated by data in each of the plurality of data bins.

8. The method of detecting anomalies in a data set of claim 7, wherein the operation of detecting at least one anomaly includes:
identifying a number of bins from the plurality of bins as being in an anomaly region based on the anomaly rules;
selecting one of the plurality of bins as corresponding to the power usage in the building during the time interval from the interval observation data;
determining whether the selected one of the plurality of bins is in the anomaly region; and
determining that an anomaly exists for the power usage in the building during the time interval if the selected one of the plurality of bins is in the anomaly region.

9. The method of detecting anomalies in a data set of claim 1, further comprising determining whether the interval observation data is anomalous based on the at least one anomaly in at least one of the plurality of anomaly categories.

10. The method of detecting anomalies in a data set of claim 9, wherein the operation of determining whether the interval observation data is anomalous further comprises:
assigning a plurality of corresponding anomaly values to each of the plurality of anomaly categories based on whether an anomaly has been identified in a corresponding one of the plurality of anomaly category;
adding together the plurality of corresponding anomaly values to create an anomaly sum for the interval observation data;
comparing the anomaly sum with an anomaly threshold; and
determining that the interval observation data is anomalous if the anomaly sum is greater than or equal to the anomaly threshold.

11. The method of detecting anomalies in a data set of claim 9, wherein the operation of determining whether the interval observation data is anomalous further comprises:
assigning a plurality of corresponding anomaly weights to each of the plurality of anomaly categories;
multiplying each of the anomaly weights by a corresponding multiplication factor based on whether an anomaly has been identified in a corresponding one of the plurality of anomaly categories to generate a plurality of corresponding anomaly values;
adding together the plurality of corresponding anomaly values to create an anomaly sum for the interval observation data;
comparing the anomaly sum with an anomaly threshold; and
determining that the interval observation data is anomalous if the anomaly sum is greater than or equal to the anomaly threshold,
wherein the corresponding multiplication factor is a set negative number if no anomaly has been identified in the corresponding one of the plurality of anomaly categories, and the corresponding multiplication factor is a set positive number if an anomaly has been identified in the corresponding one of the plurality of anomaly categories.

12. The method of detecting anomalies in a data set of claim 1, further comprising:
determining a plurality of anomaly metric values for each of a plurality of anomaly metrics;
determining a plurality of corresponding correlation values between each separate pair of the plurality of anomaly metric values;
determining that one of the plurality of corresponding correlation values between a first anomaly metric value of the plurality of anomaly metric values and a second anomaly metric value of the plurality of anomaly metric values is above a set correlation threshold;
selecting the first anomaly metric value as a principal anomaly metric value; and
discarding the second anomaly metric value.

13. A system for detecting anomalies in a data set, comprising:
a memory; and
a processor cooperatively operable with the memory, and configured to, based on instructions stored in the memory,
receive historical utility data regarding power usage in a building over a period of time, and storing the historical usage data in a computer memory;
receive anomaly metrics for a plurality of anomaly categories related to the historical utility data and storing the anomaly metrics in the computer memory;
receive anomaly rules for the plurality of anomaly categories and storing the anomaly rules in the computer memory;
build an anomaly model for each of the plurality of anomaly categories via a data processor, by transforming the historical utility data into a user-readable format based on the anomaly metrics, the anomaly model including a plurality of corresponding histograms;
receive interval observation data after building the anomaly model for each of the plurality of anomaly categories, the interval observation data relating to power usage in the building during a time interval after the period of time, and storing the interval observation data in the computer memory; and
detect at least one anomaly in at least one of the plurality of anomaly categories via the data processor using the plurality of corresponding histograms, the interval observation data, and the anomaly rules.

14. The system for detecting anomalies in a data set of claim 13, wherein the plurality of anomaly categories includes at least one of:
an average energy usage for the building above a mean energy usage within a specified operating time on a subject day,
an operational average hourly energy usage for the building during the specified operating time,
a non-operational average hourly energy usage for the building during a time other than the specified operating time on the subject day,
a time interval between a beginning of the specified operating time and a time when an actual energy usage for the building reaches the mean energy usage,
a ratio of total daily energy usage in the building to twenty-four times a daily peak value for energy usage,
a highest daily power load within a set time window during the specified operating time,
a total energy usage in the building for the subject day,
a total energy usage in the building above the mean energy usage for the subject day,
a median daily energy usage in the building on the subject day,
an operating usage variability within the specified operating time,
a non-operating usage variability within the time other than the specified operating time on the subject day, and
a peak operating load during the subject day.

15. The system for detecting anomalies in a data set of claim 13, wherein
the historical utility data includes a plurality of data entries, each corresponding to a different time interval in the period of time,
each of the plurality of data entries includes one or more pieces of power usage data related to a corresponding different time interval, and
the function of building the anomaly model includes:
identifying a plurality of data bins, each data bin identifying an equal range of power usage from a minimum power usage among the historical utility data to a maximum power usage among the historical utility data;
sorting each of the plurality of data entries into one of the plurality of data bins corresponding to a power usage associated with the corresponding one of the plurality of data entries; and
creating a histogram populated by data in each of the plurality of data bins.

16. The system for detecting anomalies in a data set of claim 15, wherein the function of detecting at least one anomaly includes:
identifying a number of bins from the plurality of bins as being in an anomaly region based on the anomaly rules;
selecting one of the plurality of bins as corresponding to the power usage in the building during the time interval from the interval observation data;
determining whether the selected one of the plurality of bins is in the anomaly region; and
determining that an anomaly exists for the power usage in the building during the time interval if the selected one of the plurality of bins is in the anomaly region.

17. The system for detecting anomalies in a data set of claim 13, wherein the processor is further configured to
determine whether the interval observation data is anomalous based on the at least one anomaly in at least one of the plurality of anomaly categories.

18. The system for detecting anomalies in a data set of claim 17, wherein during the operation of determining whether the interval observation data is anomalous, the processor is further configured to:
assigning a plurality of corresponding anomaly values to each of the plurality of anomaly categories based on whether an anomaly has been identified in a corresponding one of the plurality of anomaly category;
add together the plurality of corresponding anomaly values to create an anomaly sum for the interval observation data;
compare the anomaly sum with an anomaly threshold; and
determine that the interval observation data is anomalous if the anomaly sum is greater than or equal to the anomaly threshold.

19. The system for detecting anomalies in a data set of claim 17, wherein during the operation of determining whether the interval observation data is anomalous the processor is further configured to:
assign a plurality of corresponding anomaly weights to each of the plurality of anomaly categories
multiply each of the anomaly weights by a corresponding multiplication factor based on whether an anomaly has been identified in a corresponding one of the plurality of anomaly categories to generate a plurality of corresponding anomaly values;
add together the plurality of corresponding anomaly values to create an anomaly sum for the interval observation data;
compare the anomaly sum with an anomaly threshold; and
determine that the interval observation data is anomalous if the anomaly sum is greater than or equal to the anomaly threshold,
wherein the corresponding multiplication factor is a set negative number if no anomaly has been identified in the corresponding one of the plurality of anomaly categories, and the corresponding multiplication factor is a set positive number if an anomaly has been identified in the corresponding one of the plurality of anomaly categories.

20. The system for detecting anomalies in a data set of claim 13, wherein the processor is further configured to
determine a plurality of anomaly metric values for each of a plurality of anomaly metrics;
determine a plurality of corresponding correlation values between each separate pair of the plurality of anomaly metric values;
determine that one of the plurality of corresponding correlation values between a first anomaly metric value of the plurality of anomaly metric values and a second anomaly metric value of the plurality of anomaly metric values is above a set correlation threshold;
select the first anomaly metric value as a principal anomaly metric value; and
discard the second anomaly metric value.
